(19) United States
(12) Patent Application Publication
(10) Pub. No.: US 2024/0054252 A1
(43) Pub. Date: Feb. 15, 2024

(54) REVERSE ENGINEERING SUPPORT APPARATUS

(71) Applicant: Keyence Corporation, Osaka (JP)

(72) Inventors: Kazusa AOKI, Osaka (JP); Masaki FUJIWARA, Osaka (JP); Jun TABUCHI, Osaka (JP)

(73) Assignee: Keyence Corporation, Osaka (JP)

(21) Appl. No.: 18/222,490

(22) Filed: Jul. 17, 2023

(30) Foreign Application Priority Data
Aug. 9, 2022 (JP) 2022-127395
Jun. 13, 2023 (JP) 2023-096924

(51) Int. Cl. G06F 30/10

(52) U.S. Cl. CPC G06F 30/10

(57) ABSTRACT

CAD data, which can be directly used for a design drawing, can be easily created from geometric element following mesh data. Provided is a reverse engineering support apparatus that converts mesh data obtained by measuring a three-dimensional shape of a workpiece into CAD data and outputs the CAD data. The reverse engineering support apparatus includes: a data acquisition unit that acquires mesh data; an extraction unit that extracts geometric element data from the mesh data; a rounding unit that executes rounding on a characteristic value of the geometric element data extracted by the extraction unit; a conversion unit that converts the geometric element data subjected to the rounding into CAD data; and an output unit that outputs the CAD data.

### CROSS-REFERENCE TO RELATED APPLICATIONS

The present application claims foreign priority based on Japanese Patent Application No. 2022-127395, filed Aug. 9, 2022, and No. 2023-096924, filed Jun. 13, 2023, the contents of which are incorporated herein by references.

### BACKGROUND OF THE INVENTION

### 1. Field of the Invention

The invention relates to a reverse engineering support apparatus that supports reverse engineering for creating a CAD drawing from data obtained by measuring a three-dimensional shape.

### 2. Description of Related Art

A conventional three-dimensional measurement apparatus is disclosed in JP 2017-227611 A. This three-dimensional shape measurement device creates mesh data including a large number of polygons from a point cloud obtained by scanning a solid.

Further, a geometric element such as a plane, a cylinder, and a rectangular parallelepiped is extracted from the mesh data and converted into CAD data, so that reverse engineering can be easily performed.

However, the optical resolution of a characteristic value such as a coordinate value or a dimensional value of the geometric element extracted from the mesh data at the time of performing the reverse engineering is based on the optical resolution of the measurement apparatus.

Therefore, there is a difference between the characteristic value such as the coordinate value or the dimensional value of the extracted geometric element and a design intention of a user, and it is difficult to obtain CAD data as intended by the user even if the extracted geometric element is converted into CAD data.

### SUMMARY OF THE INVENTION

An object of the invention is to provide a reverse engineering support apparatus capable of reflecting a design intention on a geometric element extracted from mesh data and converting the geometric element into CAD data.

In order to achieve the above object, according to one embodiment of the invention, a reverse engineering support apparatus converts mesh data obtained by measuring a three-dimensional shape of a workpiece into CAD data and outputs the CAD data. The reverse engineering support apparatus includes: a data acquisition unit that acquires the mesh data; an extraction unit that extracts geometric element data from the mesh data; a rounding unit that executes rounding on a coordinate value or a dimensional value of the geometric element data extracted by the extraction unit; a conversion unit that converts the geometric element data subjected to the rounding by the rounding unit into CAD data; and an output unit that outputs the CAD data converted by the conversion unit.

According to another embodiment of the invention, the reverse engineering support apparatus having the above-described configuration further includes a storage unit that stores the geometric element data before being subjected to rounding by the rounding unit as primary geometric element data, in which the rounding unit executes rounding on the primary geometric element data stored in the storage unit to generate secondary geometric element data.

According to still another embodiment of the invention, the reverse engineering support apparatus having the above-described configuration further includes a reception unit that receives selection of a conversion mode for executing conversion into CAD data from a first conversion mode of generating primary CAD data obtained by converting the primary geometric element data before the rounding into CAD data and a second conversion mode of generating secondary CAD data obtained by converting the secondary geometric element data after the rounding into CAD data, in which the conversion unit executes the conversion into the CAD data based on the conversion mode received by the reception unit.

According to still another embodiment of the invention, in the reverse engineering support apparatus having the above-described configuration, the rounding unit executes the rounding with the number of significant digits to be processed that is coarser than a first number of significant digits which is the number of significant digits in workpiece measurement.

According to still another embodiment of the invention, the reverse engineering support apparatus having the above-described configuration further includes a display control unit that causes a display unit to display a three-dimensional shape based on the mesh data. The display control unit causes the display unit to display the three-dimensional shape with display resolution of a second number of significant digits which is the number of significant digits of the display unit. The rounding unit executes the rounding with the number of significant digits to be processed that is coarser than the second number of significant digits.

According to still another embodiment of the invention, in the reverse engineering support apparatus having the above-described configuration, the reception unit receives inputs of a design value and a tolerance corresponding to the workpiece. The rounding unit determines whether to execute the rounding based on whether a difference value between the primary geometric element data and the design value is larger than the tolerance. The conversion unit converts the primary geometric element data into the primary CAD data in the first conversion mode in a case where it is determined that the difference value between the primary geometric element data and the design value is larger than the tolerance by the determination, and converts the secondary geometric element data into the secondary CAD data in the second conversion mode in a case where it is determined that the difference value between the primary geometric element data and the design value is smaller than the tolerance by the determination.

According to still another embodiment of the invention, in the reverse engineering support apparatus having the above-described configuration, the reception unit receives inputs of a design value and a tolerance corresponding to the workpiece. The rounding unit determines whether to execute the rounding based on whether a difference value between the primary geometric element data and the design value is larger than the tolerance. The conversion unit converts the primary geometric element data into the primary CAD data in the first conversion mode in a case where the rounding unit determines that the difference value between the primary geometric element data and the design value is smaller than the tolerance by the rounding unit, and converts the secondary geometric element data into the secondary CAD data in the second conversion mode in a case where the rounding unit determines that the difference value between the primary geometric element data and the design value is larger than the tolerance.

According to still another embodiment of the invention, in the reverse engineering support apparatus having the above-described configuration, the reception unit receives an input of an allowable degree corresponding to the geometric element data. The extraction unit extracts a plurality of pieces of geometric element data from the mesh data. The rounding unit determines, for each of the plurality of pieces of geometric element data, whether a difference between the coordinate value or the dimensional value of the secondary geometric element data and the coordinate value or the dimensional value of the primary geometric element data is larger than the allowable degree. The conversion unit converts the primary geometric element data for which the difference is determined to be larger than the allowable degree by the rounding unit into the primary CAD data in the first conversion mode, and converts the secondary geometric element data for which the difference is determined to be smaller than the allowable degree by the rounding unit into the secondary CAD data in the second conversion mode.

According to still another embodiment of the invention, in the reverse engineering support apparatus having the above-described configuration, the reception unit receives an input of an allowable degree corresponding to the geometric element data. The extraction unit extracts a plurality of pieces of geometric element data from the mesh data. The rounding unit determines, for each of the plurality of pieces of geometric element data, whether a difference between the coordinate value or the dimensional value of the secondary geometric element data and the coordinate value or the dimensional value of the primary geometric element data is larger than the allowable degree. The conversion unit converts the primary geometric element data for which the difference is determined to be smaller than the allowable degree by the rounding unit into the primary CAD data in the first conversion mode, and converts the secondary geometric element data for which the difference is determined to be larger than the allowable degree by the rounding unit into the secondary CAD data in the second conversion mode.

According to still another embodiment of the invention, in the reverse engineering support apparatus having the above-described configuration, the storage unit stores a reference table in which a plurality of types of geometric element data are associated with information on whether to execute rounding on coordinate values and dimensional values of the plurality of types of geometric element data, and the rounding unit specifies a target to be subjected to the rounding based on the reference table stored in the storage unit, acquires at least one of a coordinate value or a dimensional value corresponding to the specified target, and executes the rounding.

According to still another embodiment of the invention, the reverse engineering support apparatus having the above-described configuration further includes a setting unit configured to make a setting of information of the reference table. The information of the reference table is updated according to the setting of the information of the reference table by the setting unit.

According to still another embodiment of the invention, in the reverse engineering support apparatus having the above-described configuration, the extraction unit extracts a plurality of pieces of geometric element data from the mesh data. The storage unit stores a processing setting table in which the plurality of pieces of geometric element data extracted by the extraction unit and reference values of the rounding are associated for each piece of the geometric element data. The rounding unit refers to the processing setting table stored in the storage unit, acquires a reference value corresponding to geometric element data for which the rounding is to be executed, and executes the rounding on at least one of the coordinate value or the dimensional value based on the acquired reference value.

According to still another embodiment of the invention, in the reverse engineering support apparatus having the above-described configuration, the processing setting table has an execution determination value used to determine whether to execute the rounding for each piece of the geometric element data. The rounding unit determines whether to execute the rounding based on the execution determination value of the processing setting table, and executes the rounding for the geometric element data for which it has been determined to execute the rounding by the determination.

According to still another embodiment of the invention, in the reverse engineering support apparatus having the above-described configuration, the conversion unit converts the secondary geometric element data subjected to the rounding into the secondary CAD data for the geometric element data for which it has been determined to execute the rounding based on the execution determination value. The primary geometric element data is converted into the primary CAD data for the geometric element data for which it has been determined not to execute the rounding based on the execution determination value. The output unit outputs CAD data in which the primary CAD data and the secondary CAD data are assembled.

According to still another embodiment of the invention, in the reverse engineering support apparatus having the above-described configuration, the conversion unit converts at least one piece of primary geometric element data into the primary CAD data, and converts at least one piece of secondary geometric element data into the secondary CAD data. The output unit outputs CAD data in which the primary CAD data and the secondary CAD data are assembled.

According to the invention, the geometric element extracted from the mesh data can be converted into the CAD data while reflecting the design intention.

### BRIEF DESCRIPTION OF THE DRAWINGS

FIG. 1 is a system diagram illustrating a configuration example of a three-dimensional measurement apparatus of one embodiment;

FIG. 2 is a block diagram illustrating a configuration of a reverse engineering support apparatus included in the three-dimensional measurement apparatus;

FIG. 3 is an example of a basic shape list table illustrating basic shapes and characteristic values;

FIG. 4 is a flowchart illustrating an example of an operation of the three-dimensional measurement apparatus;

FIG. 5 is a flowchart illustrating an operation in a CAD data creation process;

FIG. 6 is a schematic view of an example of a primary geometric element database;

FIG. 7 is a schematic view of an example of a secondary geometric element database;

FIG. 8 is a flowchart illustrating an operation in a geometric element data extraction process;

FIG. 9 is a schematic view of an example of a three-dimensional display screen;

FIG. 10 is a schematic view of an example of a selection screen;

FIG. 11 is a schematic view illustrating an example of a reference table;

FIG. 12 is a schematic view illustrating an example of a processing setting table;

FIG. 13 is a flowchart illustrating an operation in a processing setting table creation process;

FIG. 14 is a schematic view illustrating an example of a processing condition input screen displayed on a display unit;

FIG. 15 is mesh data of a sphere measured by the three-dimensional measurement apparatus;

FIG. 16 is a schematic view illustrating the distribution of radii of the sphere illustrated in FIG. 15;

FIG. 17 is a flowchart illustrating an operation of rounding for executing rounding;

FIG. 18 is a schematic view of primary geometric element data of an example;

FIG. 19 is a schematic view of secondary geometric element data obtained by rounding the geometric element data illustrated in FIG. 18;

FIG. 20 is a flowchart illustrating a part of another example of rounding;

FIG. 21 is a schematic view of primary geometric element data of an example;

FIG. 22 is a schematic view of secondary geometric element data obtained by rounding the geometric element data of the geometric element illustrated in FIG. 21; and

FIG. 23 is a flowchart illustrating a part of still another example of rounding.

### DETAILED DESCRIPTION OF PREFERRED EMBODIMENTS

<Three-Dimensional Measurement Apparatus 1>

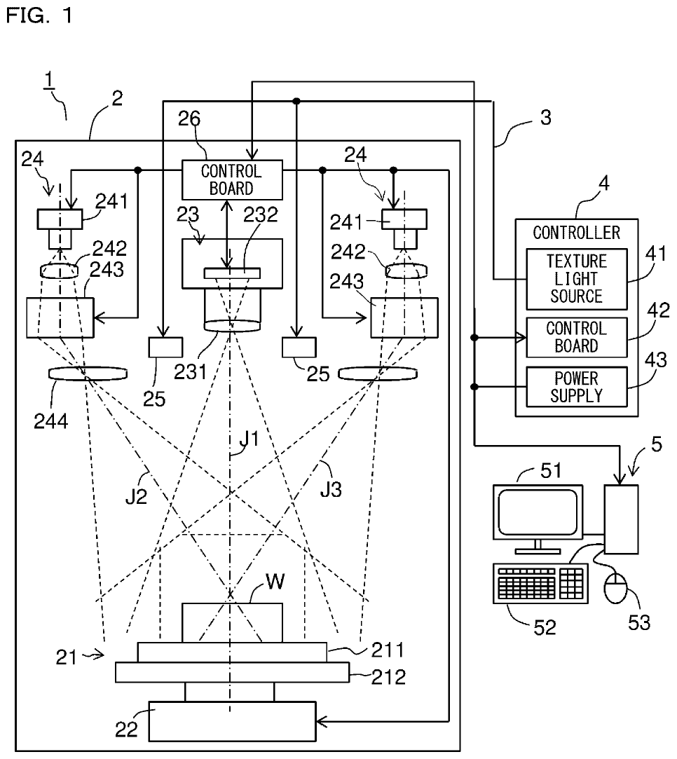

Hereinafter, an embodiment of the invention will be described with reference to the drawings. FIG. 1 is a system diagram illustrating a configuration example of a three-dimensional measurement apparatus 1 of one embodiment. As will be described in detail later, the three-dimensional measurement apparatus 1 measures a three-dimensional shape of the workpiece W to acquire mesh data. Then, a reverse engineering support apparatus 7 converts the mesh data acquired by the three-dimensional measurement apparatus 1 into CAD data and outputs the CAD data. As a result, reverse engineering of the workpiece W can be performed. The three-dimensional measurement apparatus 1 is a measurement device that optically measures a shape of the workpiece W, and includes a measurement unit 2, a controller 4, and an information processing terminal 5.

<Measurement Unit 2>

The measurement unit 2 includes a stage 21, a rotation drive unit 22, an imaging unit 23, light projection units 24, texture illumination emission units 25, and a control board 26. The measurement unit 2 irradiates the workpiece W on the stage 21 with detection light of visible light, receives the detection light reflected by the workpiece W, and generates a captured image.

The stage 21 is a work table having a horizontal and flat placement surface on which the workpiece W is to be placed. The stage 21 includes a disk-shaped stage plate 211 and a stage base 212 that supports the stage plate 211.

The rotation drive unit 22 rotates the stage 21 about a rotation axis in the vertical direction in order to adjust an imaging angle with respect to the workpiece W on the stage 21.

The imaging unit 23 is a camera with fixed magnification that captures an image of the workpiece W on the stage 21, and includes a light receiving lens 231 and an imaging element 232. The imaging element 232 receives light from the workpiece W via the light receiving lens 231 and generates a captured image. As the imaging element 232, for example, an image sensor such as a charge coupled device (CCD) or a complementary metal oxide semiconductor (CMOS) is used. The imaging element 232 is, for example, a monochrome image sensor. Note that the magnification of the imaging unit 23 is not necessarily the fixed magnification, and a camera with variable magnification may be used.

The light projection unit 24 is an illumination apparatus that irradiates the workpiece W on the stage 21 with measurement light, and includes a projection light source 241, a collector lens 242, a pattern generation unit 243, and a light projection lens 244. As the projection light source 241, for example, a light emitting diode (LED) or a halogen lamp that generates monochromatic light is used. It is more advantageous to use the monochromatic projection light source 241 as the projection light source 241 than to use a white light source since chromatic aberration correction and the like are easy. Further, it is preferable to use a blue light source, for example, a blue LED as the projection light source 241 since a shorter wavelength is more advantageous for increasing the resolution of three-dimensional shape data. However, a wavelength at which the imaging element 232 can receive light with a favorable S/N is selected.

The detection light emitted from the projection light source 241 is incident on the pattern generation unit 243 via the collector lens 242. Then, the detection light emitted from the pattern generation unit 243 is emitted to the workpiece W on the stage 21 via the light projection lens 244.

The pattern generation unit 243 is an apparatus configured to generate pattern light for structured illumination, and can switch between uniform detection light and detection light having a two-dimensional pattern. For example, a digital micromirror device (DMD) or a liquid crystal panel is used as the pattern generation unit 243. The DMD is a display element in which a large number of minute mirrors are two-dimensionally arranged, and a bright state and a dark state can be switched for each pixel by controlling an inclination of each of the mirrors.

Examples of a structured illumination method for measuring a three-dimensional shape of the workpiece W using the principle of triangulation include a sinusoidal phase-shifting method, a multi-slit method, a spatial coding method, and the like. The sinusoidal phase-shifting method is an illumination method in which a sinusoidal stripe pattern is projected on the workpiece W, and a captured image is acquired each time the stripe pattern is moved at a pitch shorter than the sinusoidal cycle. Point cloud data representing the three-dimensional shape of the workpiece W is generated by obtaining a phase value of each pixel from a luminance value of each captured image and converting the value into height information. Then, mesh data in which polygonal planes (polygons) coupling a plurality of point clouds of the point cloud data are combined is generated using a predetermined algorithm. In the following description, three-dimensional shape data includes point cloud data and mesh data.

The multi-slit method is an illumination method in which a thin stripe pattern is projected on the workpiece W, and of a captured image is acquired each time the stripe pattern is moved at a pitch narrower than an interval between stripes. Three-dimensional shape data is obtained by determining a capturing timing of the maximum luminance of each pixel from a luminance value of each captured image and converting the timing into height information.

The spatial coding method is an illumination method in which a plurality of stripe patterns having different stripe pattern widths and the duty ratio of black/white being 50% are sequentially projected onto the workpiece W to acquire captured images. Three-dimensional shape data is obtained by determining a code value of each pixel from a luminance value of each captured image and converting the value into height information.

In the pattern generation unit 243, the above-described stripe pattern can be generated as the two-dimensional pattern. In the three-dimensional measurement apparatus 1 of the present embodiment, three-dimensional shape data is acquired with high optical resolution and high accuracy by combining the multi-slit method and the spatial coding method.

Further, two light projection units 24 are arranged in a left-right symmetrical manner across the imaging unit 23. Light projection axes J2 and J3 of the respective light projection unit 24 are inclined with respect to a light reception axis J1 of the imaging unit 23 in order to use the principle of triangulation. In the light projection units 24, the light projection axes J2 and J3 are inclined by offsetting the light projection lenses 244 toward the light reception axis J1 with respect to optical axes of the projection light sources 241, the collector lenses 242, and the pattern generation units 243. Since such a configuration is adopted, the measurement unit 2 can be downsized as compared with a case where the entire light projection unit 24 is inclined.

The texture illumination emission unit 25 emits uniform illumination light of visible light toward the workpiece W on the stage 21 in order to detect a color, a pattern, and the like of the workpiece W as surface texture information. The texture illumination emission units 25 are arranged to surround the light receiving lens 231 of the imaging unit 23 with light projection axes being substantially parallel to the light reception axis J1 of the imaging unit 23. Therefore, a shadow is less likely to be formed on the workpiece W, and a blind spot at the time of capturing is reduced as compared with the illumination from the light projection units 24.

The control board 26 is a circuit board provided with a control circuit that controls the rotation drive unit 22, a drive circuit that drives the projection light sources 241 and the pattern generation units 243 of the light projection units 24, a processing circuit that processes a detection signal from the imaging element 232 of the imaging unit 23, and the like. That is, the control board 26 controls each unit of the measurement unit 2 and processes the detection signal detected by the imaging unit 23.

The controller 4 is a control apparatus of the measurement unit 2, and includes a texture light source 41, a control board 42, and a power supply 43. The texture light source 41 generates illumination light for texture illumination. The control board 42 is provided with a drive circuit and the like for the texture light source 41. The power supply 43 supplies power to each device in the measurement unit 2.

For example, the texture light source 41 sequentially turns on illumination light of each color of red (R), green (G), and blue (B) in order to obtain a color texture image from a captured image. When the imaging element 232 is a monochrome image sensor, it is difficult to acquire color information in a case where texture information is acquired using a white light source as the texture light source 41. Therefore, the texture light source 41 performs illumination by switching among RGB.

The information processing terminal 5 is a terminal apparatus that controls the measurement unit 2 and performs screen display of a captured image, registration of setting information for dimension measurement, generation of three-dimensional shape data, dimension calculation of the workpiece W, and the like.

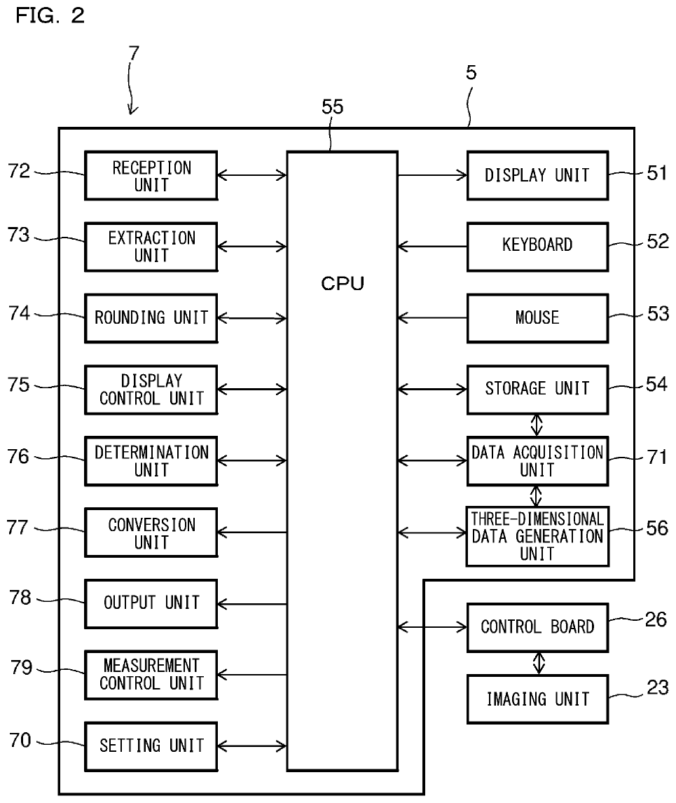

The information processing terminal 5 includes a display unit 51, a keyboard 52, a mouse 53, a storage unit 54 (see FIG. 2), a CPU 55 (see FIG. 2), and a three-dimensional data generation unit 56 (see FIG. 2). The CPU 55 is a control circuit or a control element that processes a given signal or data, performs various computations, and outputs computation results. In the present specification, the CPU 55 means an element or a circuit that performs computations, and is not limited to its name. The CPU 55 is not limited to, for example, a CPU for a general-purpose PC and processors such as an MPU, a GPU, and a TPU, but is a concept including processors such as an FPGA, an ASIC, and an LSI, a microcomputer, and a chip set such as an SoC.

The storage unit 54 is a circuit that includes storage media such as a semiconductor memory such as a ROM or a RAM, a portable semiconductor memory such as a flash memory, and a hard disk or that is connected to the storage media. The storage unit 54 stores the operation program, the setting information, the mesh data of the three-dimensional shape, and the like. Further, the storage unit 54 stores data tables such as a reference table Tb1 and a processing setting table Tb3.

The display unit 51 is, for example, a monitor apparatus that includes a display panel such as a liquid crystal panel or an organic EL panel and displays the captured image, the mesh image, the setting information, and the like on the screen. The keyboard 52 and the mouse 53 are input apparatuses used by a user to perform operation input. Note that, as an operation input apparatus, a so-called touch panel apparatus used to perform input by coming into contact with an image displayed on the display unit 51 may be adopted. The information processing terminal 5 is, for example, a personal computer, is connected to the control board 26 of the measurement unit 2, and acquires imaging data from the control board 26.

The three-dimensional data generation unit 56 may be a program operated by the CPU 55. In this case, the program of the three-dimensional data generation unit 56 is stored in the storage unit 54. That is, in the information processing terminal 5, the CPU 55 realizes the function of the three-dimensional data generation unit 56. The three-dimensional data generation unit 56 measures position information of a plurality of measurement points in a three-dimensional space, and generates point cloud data representing a three-dimensional shape of the workpiece W. Note that the point cloud data is generated based on, for example, a captured image acquired from the imaging unit 23 of the measurement unit 2. Then, mesh data in which surfaces are covered with polygons having a plurality of point clouds, set by a predetermined algorithm in the point cloud data, as vertexes is generated.

The mesh data generated by the three-dimensional data generation unit 56 is stored in the storage unit 54. Note that the imaging data and the point cloud data may also be stored in the storage unit 54. At this time, the imaging data and the point cloud data may be stored in association with the mesh data. The three-dimensional data generation unit 56 may be an electric circuit independent of the CPU 55.

### <Reverse Engineering Support Apparatus 7>

FIG. 2 is a block diagram illustrating a configuration of the reverse engineering support apparatus 7 included in the three-dimensional measurement apparatus 1. The reverse engineering support apparatus 7 includes the information processing terminal 5 and includes a CPU 55 that controls each unit. The keyboard 52, the mouse 53, and the storage unit 54 are connected to the CPU 55. Further, the display unit 51 and the imaging unit 23 are connected to the CPU 55 via the display control unit 75 and the control board 26, respectively.

As illustrated in FIG. 2, the reverse engineering support apparatus 7 includes a data acquisition unit 71, a reception unit 72, an extraction unit 73, a rounding unit 74, a display control unit 75, a determination unit 76, a conversion unit 77, and an output unit 78. The reception unit 72, the extraction unit 73, the rounding unit 74, the display control unit 75, the determination unit 76, the conversion unit 77, and the output unit 78 may be software that functions by executing an operation program of the reverse engineering support apparatus 7, or may be realized by the CPU 55.

The data acquisition unit 71 acquires mesh data (polygon data) of the workpiece W measured by the measurement unit 2. In the reverse engineering support apparatus 7, the mesh data acquired by the data acquisition unit 71 is stored in the storage unit 54. Further, the data acquisition unit 71 passes the acquired mesh data to the extraction unit 73 and the display control unit 75. Although the configuration in which the data acquisition unit 71 acquires the mesh data from the measurement unit 2 is illustrated in the present embodiment, the embodiment is not limited thereto. There is also a case where the data acquisition unit 71 reads three-dimensional data (mesh data) stored in the storage unit 54 and passes the three-dimensional data to the extraction unit 73 and the display control unit 75. Furthermore, it may be configured to acquire mesh data separately measured and stored in an external storage such as a server or a cloud.

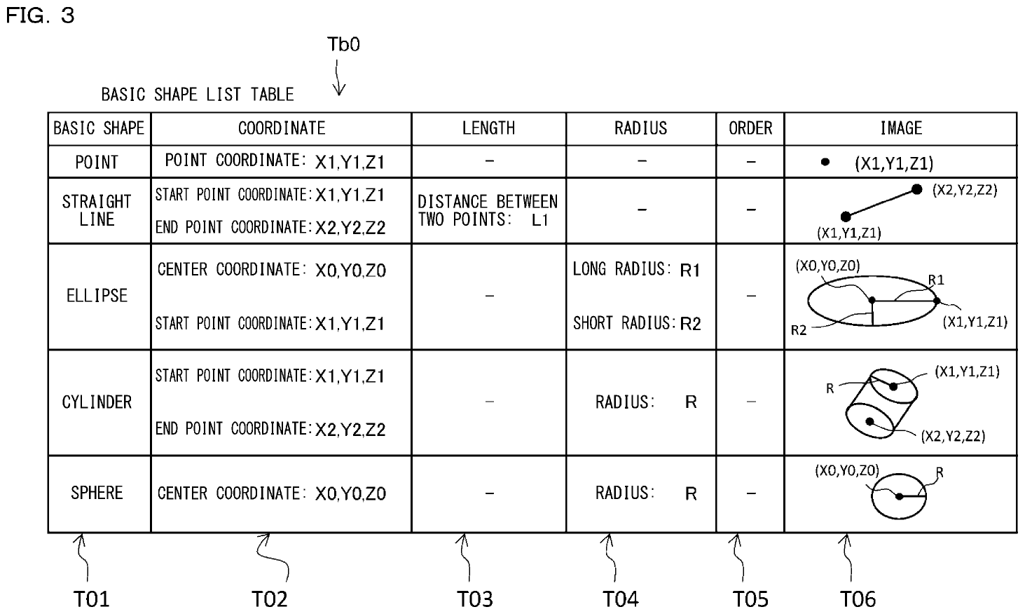

The reception unit 72 receives user's selection from geometric element candidates displayed on the display unit 51. Further, an input of a condition at the time of executing rounding on a characteristic value of geometric element data, which is data of an extracted geometric element, is received. The reception of the selection and the input from the user is executed based on a user operation through the keyboard 52 or the mouse 53. Note that the characteristic value is data necessary for specifying a geometric element. For example, when being an ellipse, a geometric element is specified by data of a center coordinate, a start point coordinate, a long radius, and a short radius (see FIG. 3). That is, the characteristic value is a numerical value such as a coordinate value or a dimensional value for specifying a geometric element.

Examples of the condition for the rounding can include selection of a rounding target of a geometric element to be subjected to rounding, a coordinate system (for example, a coordinate system of the three-dimensional measurement apparatus 1) serving as a reference in rounding, a reference value at the time of executing rounding, and an allowable degree. More specifically, the reception unit 72 can receive an input of whether to execute rounding on a rounding target (a coordinate value or a dimensional value such as a length or a radius) of the geometric element and inputs of the reference value and the allowable degree. Further, it is also possible to receive an input other than these.

The extraction unit 73 extracts geometric element data from the mesh data. Here, the geometric element data is, for example, data such as “Point”, “Straight line”, and “Ellipse” which are two-dimensional shapes, and “Cylinder”, “Sphere”, and the like which are three-dimensional shapes, in other words, data corresponding to a basic shape. A shape of the basic shape is specified by a coordinate value or a dimensional value (characteristic value). The basic shapes illustrated in FIG. 3 are examples, and are not limited thereto. The storage unit 54 may store a shape other than the basic shapes illustrated in FIG. 3 and a characteristic value thereof as a basic shape.

Here, the basic shape will be described. FIG. 3 is an example of a basic shape list table illustrating basic shapes and characteristic values. A basic shape list table Tb0 indicates shape names of the basic shapes and the characteristic values thereof stored in the storage unit 54. The basic shape is a shape to be extracted from the mesh data by the extraction unit 73.

The basic shape list table Tb0 includes a shape name field T01, a first characteristic field T02, a second characteristic field T03, a third characteristic field T04, a fourth characteristic field T05, and an image field T06.

The shape name field T01 indicates a general shape name of the basic shape. The above-described shape name of the basic shape corresponds to the shape name displayed in the shape name field T01. The first characteristic field T02 indicates data clearly indicating “Coordinate” which is a coordinate value as a characteristic value of a point necessary for specifying the basic shape. For example, in a case where the basic shape is a cylinder, it is indicated that at least coordinates of centers of circles at both ends in the axial direction are necessary. Note that the coordinates of the respective basic shapes are given as illustrated in schematic views in the image field T06.

The second characteristic field T03 indicates data clearly indicating “Length” which is a dimensional value as a characteristic value. Note that “Length”, which is the dimension of the basic shape, is redundant information defined by a start point and an end point, and thus, may be used together with the coordinate value in a format of a combination of the start point and the length, a combination of the end point and the length, or the like. Further, in a case where a shape can be specified only by the coordinate, the data clearly indicating “Length” may be omitted and “-” may be set on the second characteristic field T03. The third characteristic field T04 is “Radius” which is a dimensional value as a characteristic value set to a shape related to a circle. The image field T06 illustrates the schematic view illustrating the characteristic value in each of the basic shapes.

The extraction unit 73 searches the mesh data for portions that fit a basic shape and similar shapes thereof. Then, the extraction unit 73 specifies a portion similar to the basic shape as a geometric element candidate based on a position on the mesh data designated by the user and a type of the basic shape. Then, the extraction unit 73 extracts geometric element data obtained by fitting data of the identified geometric element candidate to the basic shape. That is, the geometric element data extracted here is data of the basic shape extracted from the mesh data. As an algorithm for fitting a shape identical or similar to the basic shape to the mesh data, a statistical method known in the related art can be used. For example, the extraction unit 73 specifies a three-dimensional position, an attitude, and a size of the geometric element candidate by the least squares method based on a distance between a measurement point constituting the mesh data and the basic shape.

The basic shapes are shapes preset in the reverse engineering support apparatus 7. The extraction unit 73 extracts the geometric element data by fitting the mesh data to the basic shapes. As described above, the basic shapes have different characteristic values and are different shapes. Therefore, an algorithm for searching the data of the geometric element candidate is set for each of the basic shapes. Thus, a basic shape can be added together with an algorithm. Examples of the addition of a basic shape can include a case where a basic shape is supplied from a manufacturer of the reverse engineering support apparatus 7. Further, in a case where the user can obtain or produce a program of an algorithm, the user may be allowed to independently add a basic shape. Note that the characteristic value is not limited to these numerical values, and any numerical value indicating a shape characteristic necessary for specifying a geometric element can be widely adopted.

The rounding unit 74 executes rounding on the geometric element data extracted by the extraction unit 73. Details of the rounding will be described later.

The display control unit 75 creates display data to be displayed on the display unit 51 based on three-dimensional shape data in the storage unit 54. For example, display data for displaying a three-dimensional shape of an object body in which a large number of measurement points are three-dimensionally arranged as viewed from a predetermined viewpoint, on the screen of the display unit 51 is created. A position, a viewpoint, and a display magnification of the three-dimensional shape (the workpiece W) in the screen can be freely designated. Further, the display control unit 75 may acquire a display resolution (resolution) of the display unit 51 and create display data optimized according to the acquired display resolution. Note that, in the case of displaying the three-dimensional shape of the workpiece W, the display control unit 75 may display the mesh data as it is, or may display the texture image mapped on the three-dimensional shape data such as the point cloud data and the mesh data.

The determination unit 76 determines whether to execute rounding on the extracted geometric element data based on the content received by the reception unit 72. Note that examples of the determination here can include a determination based on a difference between primary geometric element data before rounding and a design value, and a determination based on a deviation of secondary geometric element data after rounding from the primary geometric data before rounding. This determination process may be executed by the above-described rounding unit 74 instead of the determination unit 76.

The conversion unit 77 converts the secondary geometric element data, which is the geometric element data obtained by rounding in the rounding unit 74, into CAD data. Note that the conversion unit 77 can also convert the primary geometric element data before rounding into CAD data. That is, the conversion unit 77 can generate the CAD data in two types of conversion modes of a first conversion mode in which primary geometric element data is converted into primary CAD data and a second conversion mode in which secondary geometric element data is converted into secondary CAD data. The output unit 78 outputs the CAD data converted by the conversion unit 77.

The measurement control unit 79 controls the stage 21, the imaging unit 23, the light projection units 24, and the texture light source 41 via the control boards 26 and 42 to capture an image of the workpiece W. The setting unit 70 sets a processing condition for performing processing to the processing setting table Tb3 and the like. Note that the setting unit 70 may set an operation condition, a measurement condition, and the like of the reverse engineering support apparatus 7 in addition to the processing condition.

The reverse engineering support apparatus 7 is a program that operates on the CPU 55 of the information processing terminal 5 in the present embodiment, but is not limited thereto, and at least a part thereof may be a dedicated electric circuit. Further, the reverse engineering support apparatus 7 may be provided independently of the information processing terminal 5. Also in this case, at least a part thereof may be a program, or at least a part thereof may be a dedicated electric circuit.

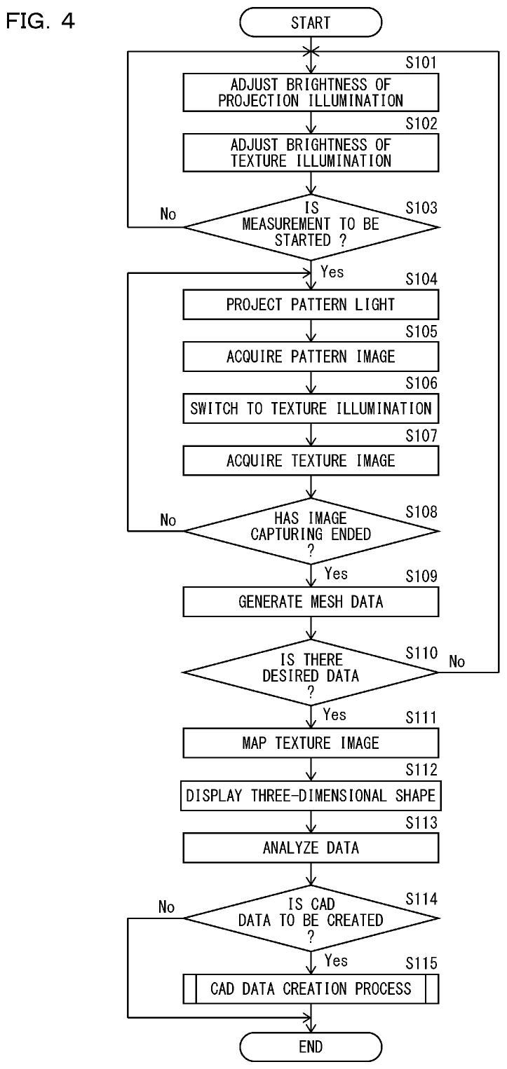

FIG. 4 is a flowchart illustrating an example of an operation of the three-dimensional measurement apparatus 1. When the three-dimensional measurement apparatus 1 is activated, the imaging unit 23 captures an image of the workpiece W placed on the stage 21 under the control of the measurement control unit 79 in Step S101. The display control unit 75 causes the display unit 51 to display the captured image obtained by capturing the workpiece W using the imaging unit 23. Then, the reception unit 72 receives adjustment of brightness of a projection illumination, and sends information on the received brightness of the projection illumination to the control board 26. The control board 26 controls the light projection units 24 based on information on the brightness of the projection illumination from the reception unit 72.

In Step S102, the measurement control unit 79 switches to a texture illumination, acquires a captured image, and displays the captured image on the display unit 51 to perform brightness adjustment of the texture illumination. This brightness adjustment is performed by causing the texture illumination emission unit 25 to sequentially or simultaneously emit illumination light of each color of red (R), green (G), and blue (B). The order of Steps S101 and S102 may be changed.

In Step S103, the measurement control unit 79 determines whether the reception unit 72 has received a measurement start instruction from the user. The processing procedure of Steps S101 and S102 are repeated until the reception unit 72 receives the measurement start instruction from the user (No in Step S103). When the reception unit 72 receives the measurement start instruction from the user (Yes in Step S103), the flow proceeds to Step S104. In Step S104, the light projection units 24 start projecting pattern light. In the next Step S105, the imaging unit 23 acquires a pattern image. This pattern image is a captured image obtained by capturing the workpiece W on the stage 21. The projection of the pattern light and the acquisition of the captured image are performed by synchronizing the pattern generation units 243 and the imaging unit 23.

In Step S106, the measurement control unit 79 switches from the pattern light from the light projection units 24 to the texture illumination from the texture illumination emission unit 25. In the next Step S107, the imaging unit 23 acquires a texture image. This texture image is obtained by combining a plurality of captured images acquired by sequentially emitting illumination light of each color of red (R), green (G), and blue (B).

In Step S108, the measurement control unit 79 determines whether image capturing has ended. At the time of continuous measurement, the measurement control unit 79 controls the imaging unit 23 and the light projection units 24 via the control board 26, and repeats the processing procedure from Step S104 to Step S107 while sequentially switching the stage 21 to a plurality of imaging angles designated in advance. When the image capturing has ended (Yes in Step S108), the flow proceeds to Step S109.

In Step S109, the three-dimensional data generation unit 56 generates mesh data of a three-dimensional shape based on the pattern image acquired in Step S105, and stores the mesh data in the storage unit 54.

In Step S110, the three-dimensional data generation unit 56 determines whether three-dimensional shape data has been obtained for a desired measurement site. When desired data is not obtained (No in Step S110), the processing procedure from Step S101 to Step S109 is repeated while changing an imaging angle, a capturing condition, and the like. When the desired data is obtained (Yes in Step S110) and an instruction for data analysis from the user is received, the flow proceeds to Step S111.

In Step S111, the measurement control unit 79 maps the texture image on the mesh data stored in Step S109. In Step S112, the display control unit 75 causes the display unit 51 to display a three-dimensional shape on which the texture image has been mapped as three-dimensional shape of the workpiece W.

In the next Step S113, the three-dimensional data generation unit 56 performs data analysis of the three-dimensional shape data to calculate desired data such as dimensions of the workpiece W. The three-dimensional data generation unit 56 stores the calculated data in the storage unit 54 in association with the mesh data.

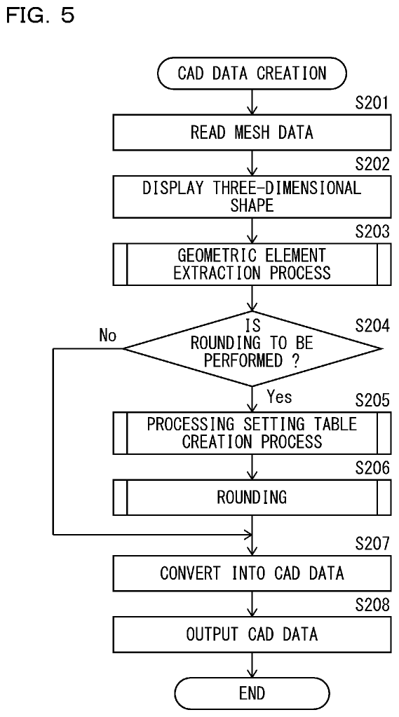

In Step S114, the three-dimensional data generation unit 56 determines whether the reception unit 72 has received an instruction to create CAD data from the mesh data. In a case where there is no instruction to create CAD data (No in Step S114), the three-dimensional data generation unit 56 ends the operation of the three-dimensional measurement apparatus 1. In a case where the reception unit 72 has received the instruction to create CAD data (Yes in Step S114), a CAD data creation process illustrated in FIG. 5 is performed by the conversion unit 77 and the like in Step S115, and then, the operation of the three-dimensional measurement apparatus 1 is ended.

In the reverse engineering support apparatus 7, elements (hereinafter, referred to as basic measurement elements) such as a distance between elements, positions of elements, a position and a shape of an element in the workpiece W, a size of an element with respect to the workpiece W, and an element to be subjected to CAD conversion, are selected. Then, the selected basic measurement elements are temporarily stored in the storage unit 54.

### <CAD Data Creation Process>

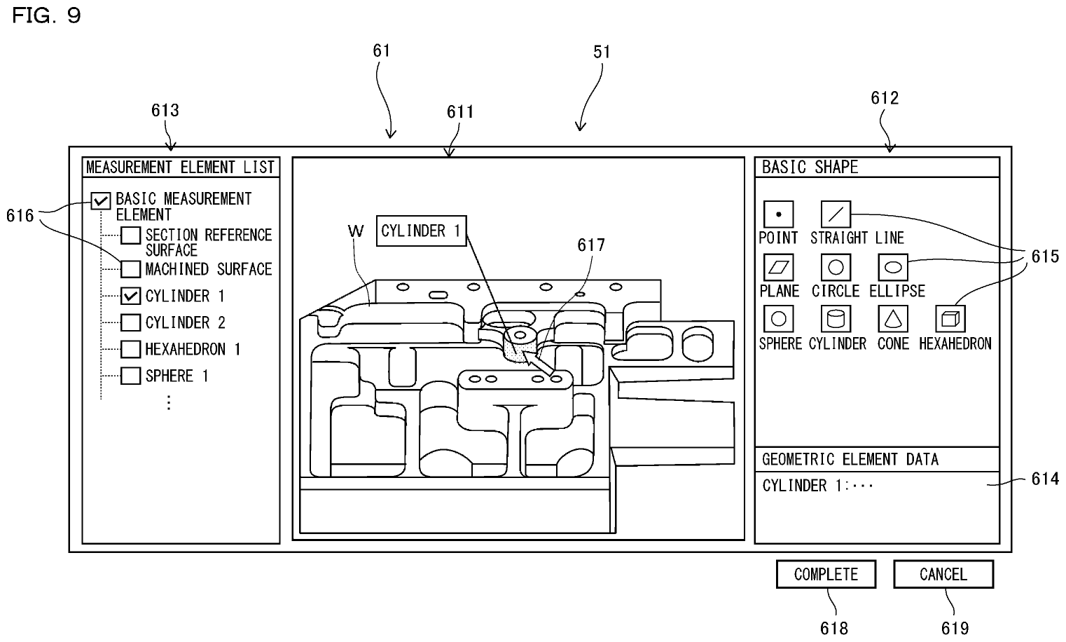

FIG. 5 is a flowchart illustrating an operation in the CAD data creation process. In Step S201, the data acquisition unit 71 reads mesh data from the storage unit 54. In Step S202, the display control unit 75 generates display data for displaying a three-dimensional shape of the workpiece W on the display unit 51 based on the mesh data acquired by the data acquisition unit 71. Then, the display control unit 75 displays the three-dimensional shape of the workpiece W on the display unit 51 based on the generated display data (a three-dimensional display screen 61 in FIG. 9 to be described later).

After the three-dimensional shape is displayed on the display unit 51, the flow proceeds to Step S203, and a geometric element extraction process of extracting geometric element data illustrated in FIG. 9 is executed by the extraction unit 73. At this time, the extraction unit 73 stores the extracted geometric element data in a primary geometric element database Db1 included in the storage unit 54 as primary geometric element data.

After the geometric element data is extracted in Step S203, the flow proceeds to Step S204. In Step S204, the determination unit 76 determines whether to execute rounding on the geometric element data. Note that this determination processing may be executed by the rounding unit 74 instead of the determination unit 76. Further, in Step S204, it can be determined not to execute rounding in a case where rounding is not to be executed for all pieces of geometric element data stored in the primary geometric element database Db1. More specifically, in a case where rounding is executed on a part of the geometric element data stored in the primary geometric element database Db1, the determination unit 76 determines to execute rounding.

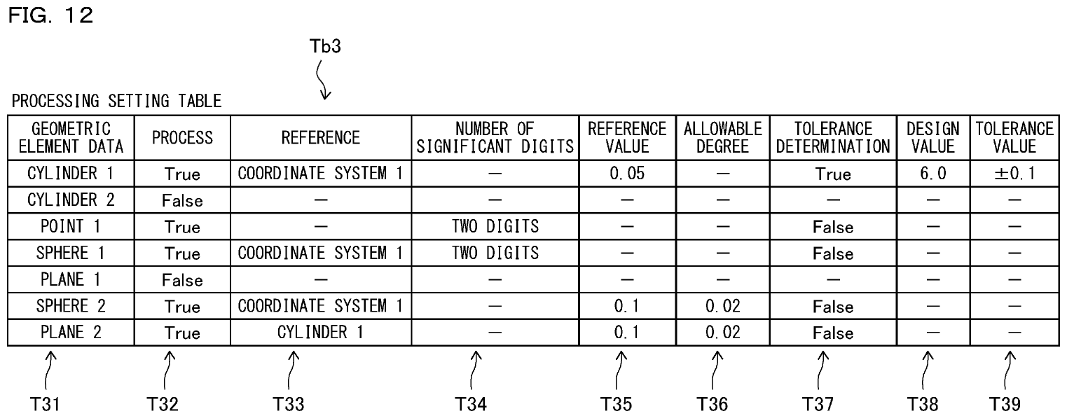

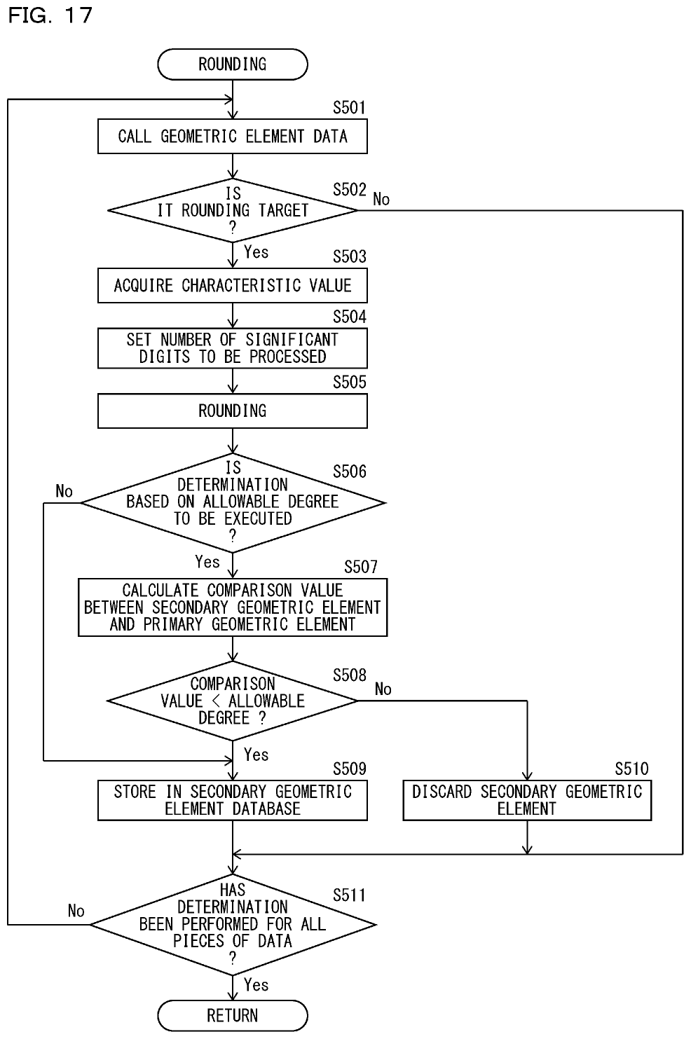

When the determination unit 76 determines to execute rounding (Yes in Step S204), the flow proceeds to Step S205. In Step S205, the setting unit 70 executes a processing setting table creation process of creating the processing setting table Tb3 illustrated in FIG. 12. In the next Step S206, rounding illustrated in FIG. 17 is executed with reference to the processing setting table Tb3. Note that details of the processing setting table creation process and the rounding will be described later.

In Step S204, when the determination unit 76 determines not to execute rounding (NO in Step S204) or after rounding of the geometric element data is executed in Step S206, the flow proceeds to Step S207. In Step S207, the conversion unit 77 illustrated in FIG. 2 converts the primary geometric element data extracted in Step S203 or the secondary geometric element data subjected to rounding in Step S206 into CAD data.

In Step S207, the conversion unit 77 refers to a secondary geometric element database Db2 to be described later, and executes CAD conversion of the secondary geometric element data in a case where the secondary geometric element data exists. Further, the conversion unit 77 executes CAD conversion of the primary geometric element data in a case where the secondary geometric element data does not exist. Note that CAD data obtained by converting the primary geometric element data is defined as primary CAD data, and CAD data obtained by converting the secondary geometric element data is defined as secondary CAD data. Further, the CAD conversion performed by the conversion unit 77 to generate the primary CAD data is referred to as a first CAD conversion mode, and the CAD conversion performed by the conversion unit 77 to generate the secondary CAD data is referred to as a second CAD conversion mode.

Next, in Step S208, the output unit 78 illustrated in FIG. 2 outputs the CAD data created in Step S207 and stores the CAD data in the storage unit 54.

Further, in a case where a plurality of pieces of geometric element data are created, the conversion unit 77 can assemble the plurality of pieces of geometric element data and convert the data into one piece of CAD data. Then, the output unit 78 outputs the one piece of CAD data assembled by the conversion unit 77. Note that the plurality of pieces of geometric element data may include primary geometric element data and secondary geometric element data in a mixed manner. That is, the conversion unit 77 can convert the primary geometric element data and the secondary geometric element data into one piece of assembled CAD data, and output the one piece of assembled CAD data from the output unit 78.

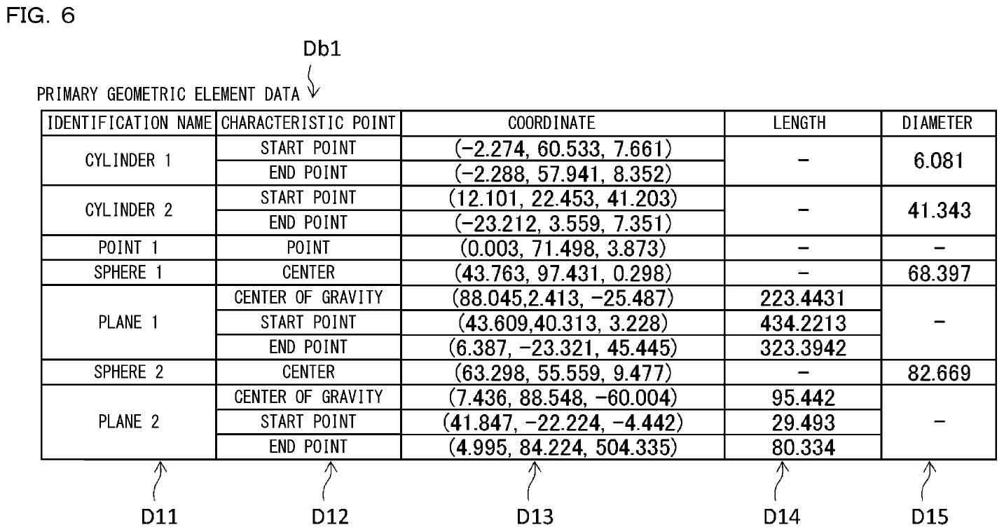

The extraction unit 73 extracts primary geometric element data from the mesh data, and stores the extracted primary geometric element data in the primary geometric element database Db1 of the storage unit 54. Here, the primary geometric element database Db1 will be described with reference to the drawing. FIG. 6 is a schematic view of an example of the primary geometric element database Db1.

The primary geometric element database Db1 illustrated in FIG. 6 includes an identification name field D11, a characteristic point field D12, a coordinate field D13, a length field D14, and a radius field D15. The identification name field D11 stores an identification name of the extracted geometric element data. In the primary geometric element database Db1 illustrated in FIG. 6, for example, “Cylinder 1” is stored as the identification name.

The characteristic point field D12 is data clearly indicating a position of “Coordinate” as a characteristic value of a point necessary for specifying the geometric element data associated with the identification name. In “Cylinder 1”, “Start point” and “End point” are stored in the characteristic point field D12. The characteristic point field D12 is information stored in the first characteristic field T02 of the basic shape list table Tb0 illustrated in FIG. 3.

A coordinate value of the position indicated in the characteristic point field D12 is stored in the coordinate field D13. Note that (X-coordinate value, Y-coordinate value, Z-coordinate value) is stored in the coordinate field D13 of the primary geometric element database Db1 illustrated in FIG. 6. For example, coordinate values are stored at the start point and the end point, respectively, in the primary geometric element database Db1.

The length field D14 stores a dimensional value of “Length” among the characteristic values of the geometric element data. Note that there is a case where certain geometric element data does not have “Length” as the characteristic value. In this case, the length field D14 corresponding to the geometric element data is indicated by “-”. For example, in the primary geometric element database Db1 illustrated in FIG. 6, in the case of “Cylinder 1”, the length field D14 is “-” since “Length” as the characteristic value is not included.

The radius field D15 stores a dimensional value of “Radius” among the characteristic values of the geometric element data. Note that there is a case where certain geometric element data does not have “Radius” as the characteristic value. In this case, the radius field D15 corresponding to the geometric element data is indicated by “-”. For example, in the case of the “Cylinder 1”, a dimensional value of “Radius” as the characteristic value is stored in the radius field D15 since “Radius” as the characteristic value is included.

The primary geometric element database Db1 illustrated in FIG. 6 stores the geometric element data extracted from the mesh data by the extraction unit 73 and the characteristic values thereof.

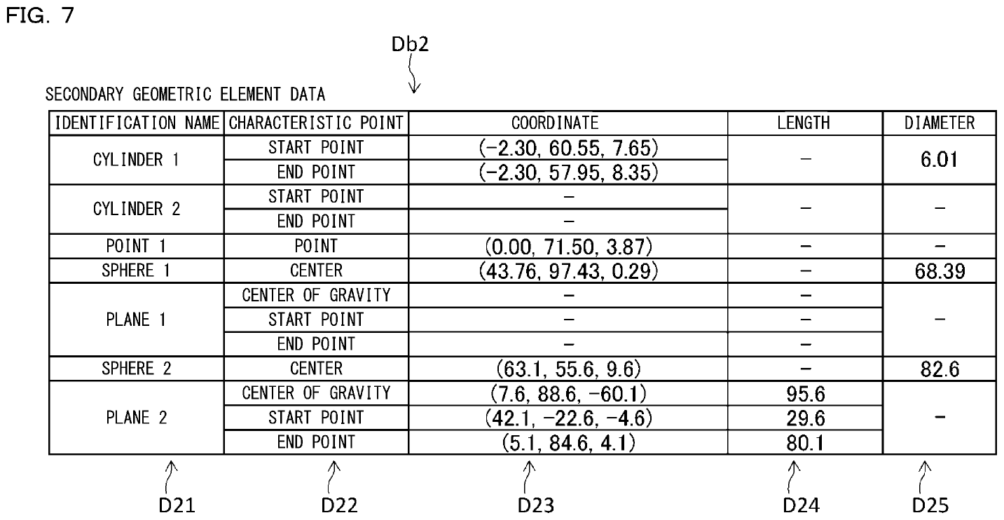

Further, the secondary geometric element data, generated as the rounding unit 74 executes rounding on the primary geometric element data, is stored in the secondary geometric element database Db2 of the storage unit 54. FIG. 7 is a schematic view of an example of the secondary geometric element database Db2. Note that each field of the secondary geometric element database Db2 is the same as each field of the primary geometric element database Db1. Therefore, detailed description of the secondary geometric element database Db2 will be omitted, and the correspondence with each field of the primary geometric element database Db1 will be described.

An identification name field D21 corresponds to the identification name field D11. A characteristic point field D22 corresponds to the characteristic point field D12. A coordinate field D23, a length field D24, and a radius field D25 correspond to the coordinate field D13, the length field D14, and the radius field D15, respectively. The identification name field D21 and the characteristic point field D22 store the same values as those in the identification name field D11 and the characteristic point field D22. Further, the coordinate field D23, the length field D24, and the radius field D25 store values after rounding of numerical values of the coordinate field D13, the length field D14, and the radius field D15, respectively.

### <Geometric Element Data Extraction Process>

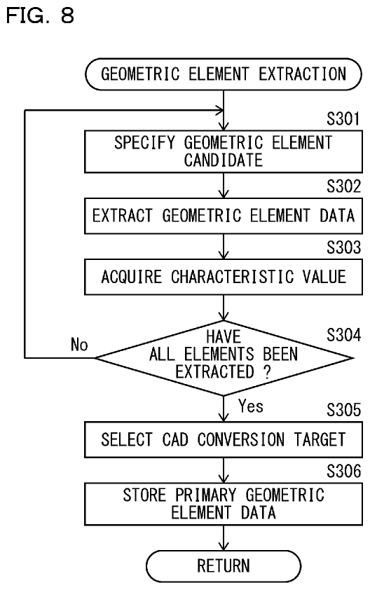

FIG. 8 is a flowchart of the geometric element data extraction process. As illustrated in FIG. 8, in Step S301, the extraction unit 73 searches for a portion (geometric element candidate) similar to a basic shape based on a position on the mesh data designated by the user and a type of the basic shape, and specifies one geometric element candidate. More specifically, the extraction unit 73 uses an algorithm for extracting geometric element data set for each of the basic shapes to specify the portion similar to the basic shape as the geometric element candidate. After the geometric element candidate is specified in Step S301, the flow proceeds to Step S302. In Step S302, the extraction unit 73 extracts one piece of geometric element data by fitting data of the identified geometric element candidate in the mesh data to the basic shape. After the geometric element data is extracted in Step S302, the flow proceeds to Step S303.

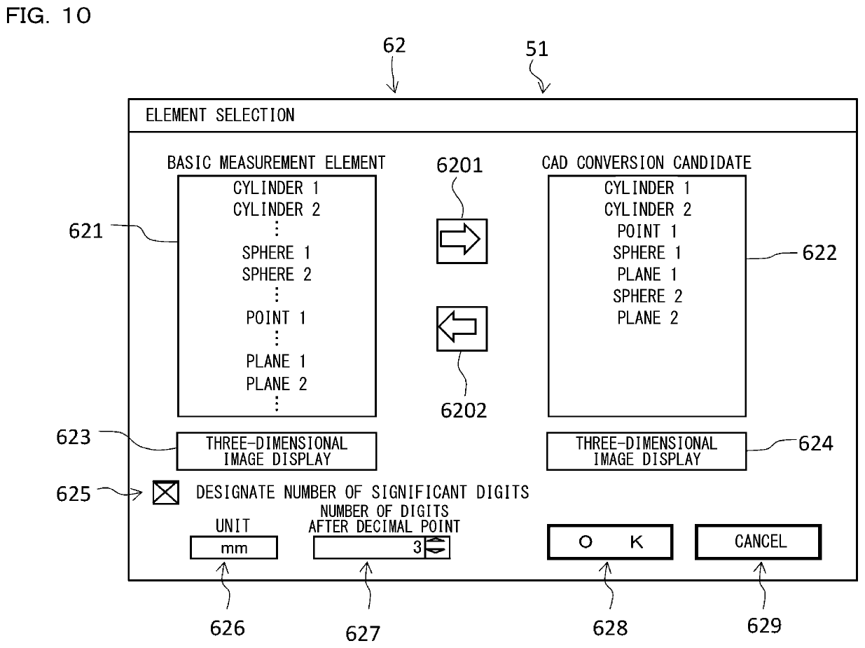

In Step S303, the extraction unit 73 acquires a characteristic value of the geometric element data extracted in Step S302. As described in the basic shape list table Tb0 illustrated in FIG. 3, the characteristic value is a numerical value such as a coordinate value or a dimensional value for specifying the geometric element (basic shape). The characteristic value of the geometric element data is stored in the storage unit 54 as a part of the basic measurement elements in association with the identification name of the geometric element data. Note that the storage of the characteristic value and the identification name of the geometric element data may be temporary storage, or may be stored until, for example, there is a deletion instruction from the user (the reception unit 72 receives that a cancel key 629 has been operated on a selection screen 62 illustrated in FIG. 10 to be described later).

In Step S304, the extraction unit 73 determines whether all pieces of geometric element data have been extracted. Here, “all pieces of geometric element data have been extracted” means that all pieces of geometric element data desired to be extracted by the user (in other words, desired to be converted to CAD data) in the mesh data have been extracted. Then, the fact that “all pieces of geometric element data have been extracted” is decided by the user. Specifically, when the reception unit 72 receives that ab OK key 628 of a selection screen 511 has been operated, the extraction unit 73 determines that the extraction unit 73 has extracted all pieces of the geometric element data.

When the extraction of all pieces of geometric element data has not been completed (No in Step S304), the extraction unit 73 repeats Steps S301 to S303 to continue extracting geometric element data. Further, when the extraction of all pieces of geometric element data has been completed (Yes in Step S304), in Step S305, the extraction unit 73 extracts a CAD conversion target element, that is, geometric element data, from the basic measurement elements currently stored in the storage unit 54.

In the next Step S306, the extraction unit 73 stores all pieces of the extracted geometric element data in the primary geometric element database Db1 (see FIG. 6) of the storage unit 54. Then, the CPU 55 ends the geometric element data extraction process, and returns to Step S204 of the flowchart illustrated in FIG. 5.

Next, the three-dimensional display screen 61 which is a user interface at the time of extracting geometric element data will be described with reference to FIG. 9. The three-dimensional display screen 61 illustrated in FIG. 9 is used to select or extract basic measurement elements to be measured in three-dimensional display of the workpiece W. Note that the “basic measurement elements” includes the geometric element data according to the present embodiment, and further includes an element for confirming a position, an element for measuring a distance, and the like. These elements are examples of the basic measurement elements, and are not limited thereto.

The three-dimensional display screen 61 illustrated in FIG. 9 includes a workpiece display area 611, a basic shape selection area 612, a measurement element display area 613, and a geometric element data display area 614. The workpiece display area 611 is an area for displaying three-dimensional shape data of the workpiece W. The three-dimensional shape data of the workpiece W based on mesh data and point cloud data is displayed in the workpiece display area 611.

Further, the three-dimensional shape data displayed in the workpiece display area 611 may be the mesh data and the point cloud data, or the mesh data mapped with a texture image may be displayed. When the mesh data mapped with the texture image is displayed in the workpiece display area 611, it is possible to reproduce an actual appearance of the workpiece W on the display unit 51. As a result, for example, the user can easily visually recognize a state of the surface of the workpiece W such as unevenness or a crack.

In the workpiece display area 611, the three-dimensional shape data of the workpiece W can be rotated. As a result, the workpiece W can be displayed while changing a viewpoint and changing an angle. Note that the three-dimensional shape of the workpiece W may be rotated for switching to a predetermined viewpoint, or may be rotated in accordance with the movement of the mouse 53 or the like.

In the basic shape selection area 612, a plurality of shape selection keys 615 for selecting the basic shapes are arranged. The plurality of shape selection keys 615 are associated with the basic shapes illustrated in FIG. 3, respectively, and the shape names of the shape name field T01 are displayed below the shape selection keys 615. Note that images indicating the basic shapes may be displayed on the shape selection keys 615.

In FIG. 9, as the plurality of shape selection keys 615, for example, two-dimensional shapes or three-dimensional shapes having similar characteristics of basic shapes are collectively arranged. However, the arrangement of the shape selection keys 615 in the basic shape selection area 612 is not limited to this arrangement, and for example, the user may change the arrangement, the arrangement in order of use frequency may be possible. Since such a basic shape selection area 612 is provided, it is easy for the user to select the basic shape.

As illustrated in FIG. 9, the selected or extracted basic measurement elements are displayed in a tree in the measurement element display area 613. The basic measurement elements are elements for measuring predetermined numerical values in the workpiece W. Examples of the basic measurement elements include two planes for measuring a distance or an angle, a sphere for measuring a surface area or a volume, and the like. Further, the basic measurement elements also include geometric element data extracted from the workpiece W.

In the present embodiment, when geometric element data is extracted from the workpiece W displayed in the workpiece display area 611, the extracted geometric element data is added to the tree display of the basic measurement elements in the measurement element display area 613.

In the tree display of the measurement element display area 613, an identification name of the geometric element data is displayed. Here, the identification name is obtained by adding a consecutive number to a shape name of a basic shape (the same shape name as the shape name field T01 in FIG. 3) such as “Cylinder 1”. However, the identification name is not limited thereto. For example, the identification name may be freely changeable by the user, or may adopt a separately defined component name or the like. In the measurement element display area 613, a check box 616 is arranged on the left side of each data. When data is selected, the geometric element data displayed in the measurement element display area 613 may be switched according to a check state of the check box 616.

In the geometric element data display area 614, an identification name and a characteristic value of the geometric element data selected in the measurement element display area 613 are displayed.

On the three-dimensional display screen 61, a cursor 617 movable in the screen is arranged. The cursor 617 operates in conjunction with the operation of the mouse 53 performed by the user. For example, a basic shape is selected by moving the cursor 617 to overlap the shape selection key 615 and clicking the mouse 53. In order to clarify the selected basic shape, a color of the selected shape selection key 615 may be changed, or a shape surrounding the periphery of the shape selection key 615 may be displayed.

When the reception unit 72 receives that the shape selection key 615 has been selected by the operation of the mouse 53, the CPU 55 notifies the extraction unit 73 of information on the selected basic shape. When the reception unit 72 receives an input of the operation of the cursor 617 on the workpiece W displayed in the workpiece display area 611, the extraction unit 73 sets a portion that includes mesh data corresponding to the cursor 617 and is similar to the basic shape as a geometric element candidate.

Then, the extraction unit 73 extracts geometric element data obtained by fitting data of the identified geometric element candidate to the basic shape. Note that the portion of the geometric element candidate of the mesh data may be displayed with a color in the three-dimensional display screen 61. Due to the display with a color, a shape of the geometric element data extracted by the user can be easily recognized, and a position, a size, and the like of the geometric element data in the workpiece W can be recognized. When extracting geometric element data, the extraction unit 73 extracts a characteristic value of the geometric element data to be extracted. The extraction unit 73 refers to the basic shape list illustrated in FIG. 3, sets the characteristic value of the geometric element data to be extracted, and acquires the characteristic value.

Further, the display control unit 75 creates display data for displaying the geometric element data so as to be superimposed on the three-dimensional shape data of the workpiece W displayed in the workpiece display area 611. Then, the display control unit 75 may display the display data of the geometric element data in the workpiece display area 611 to be superimposed on the display of the three-dimensional shape of the workpiece W.

As the geometric element data is extracted from the three-dimensional shape data of the workpiece W displayed on the display unit 51 in this manner, the user can intuitively and quickly extract the geometric element data, and the convenience of the user can be improved. Further, a plurality of pieces of geometric element data can be extracted by using the three-dimensional display screen 61.

The extraction unit 73 can extract the plurality of pieces of geometric element data while the three-dimensional display screen 61 is being displayed. Therefore, the three-dimensional display screen 61 includes a complete key 618 and a cancel key 619. The complete key 618 and the cancel key 619 are operated by the cursor 617. As described above, the cursor 617 operates as the reception unit 72 receives the operation of the mouse 53.

The complete key 618 is operated when the extraction of geometric element data is completed. When the complete key 618 has been operated, the extraction unit 73 stores the extracted geometric element data in the storage unit 54 as primary geometric element data. At this time, the extraction unit 73 stores the characteristic value of the extracted geometric element data in the storage unit 54 in association as a part of the basic measurement elements. Further, when the cancel key 619 is operated, the geometric element data extracted by the extraction unit 73 is reset and is not stored in the storage unit 54.

The conversion unit 77 converts the geometric shape data extracted by the extraction unit 73 into CAD data (hereinafter, referred to as CAD conversion). As described above, in the three-dimensional display screen 61 illustrated in FIG. 9, the basic measurement elements displayed in the measurement element display area 613 include elements other than geometric element data as a CAD conversion target. The conversion unit 77 executes the CAD conversion of the geometric element data selected from the basic measurement elements.

FIG. 10 is a schematic view of an example of the selection screen 62 for selecting geometric element data to be subjected to the CAD conversion. The selection screen 62 illustrated in FIG. 10 includes a basic measurement element display area 621, a CAD conversion target display area 622, a first element display key 623, a second element display key 624, a selection field 625 for selecting whether to receive designation of the number of significant digits, a unit input section 626, a number-of-significant-digits input section 627, the OK key 628, and the cancel key 629.

In the basic measurement element display area 621, a list of basic measurement elements selected or extracted by the reverse engineering support apparatus 7 is displayed. Note that identification names of the basic measurement elements are collectively displayed for each shape in the basic measurement element display area 621, but may be displayed in another arrangement order without being limited thereto. Further, only geometric element data extracted by the extraction unit 73 may be displayed in the basic measurement element display area 621 in the present embodiment. In the CAD conversion target display area 622, geometric element data selected from the basic measurement element display area 621 by the user is displayed. In the CAD conversion target display area 622, the geometric element data may be displayed in order of selection.

The selection screen 62 may allow the user to change an identification name displayed in the basic measurement element display area 621 and the CAD conversion target display area 622. For example, the identification names adopted in the above-described three-dimensional display screen 61 may be adopted in the basic measurement element display area 621 such that the user can change an identification name of geometric element data selected as a CAD conversion target. At this time, when the geometric element data having the identification name changed by the user is deleted from the CAD conversion target display area 622, the geometric element data may be displayed in the basic measurement element display area 621 with the changed identification name or the original identification name.

Note that an add key 6201 and a delete key 6202 are arranged between the basic measurement element display area 621 and the CAD conversion target display area 622. The add key 6201 (an arrow directed to the CAD conversion target display area 622) is operated when geometric element data selected from pieces of geometric element data displayed in the basic measurement element display area 621 is added to the CAD conversion target display area 622. Further, the delete key 6202 (an arrow directed to the basic measurement element display area 621) is operated when geometric element data selected from pieces of geometric element data displayed in the CAD conversion target display area 622 is deleted from the CAD conversion target display area 622.

An instruction to display geometric element data as a CAD conversion candidate on the display unit 51 is input to the first element display key 623. For example, when the reception unit 72 receives selection of one geometric element from a plurality of geometric elements displayed in the basic measurement element display area 621 and the reception unit 72 also receives an operation input of the first element display key 623, the display control unit 75 displays the geometric element data selected in the workpiece display area 611 of the three-dimensional display screen 61 so as to be superimposed on three-dimensional solid display of the workpiece W. The second element display key 624 has a function similar to that of the first element display key 623, and receives an instruction to display geometric element data displayed in the CAD conversion target display area 622 on the display unit 51.

A geometric element as a CAD conversion candidate and a geometric element as a CAD conversion target can be displayed to be superimposed on one three-dimensional shape. In this case, geometric element data as the CAD conversion candidate and geometric element data as the CAD conversion target may be colored in different colors or may be surrounded by different shapes to be distinguished from each other, or a mark indicating the geometric element data as the CAD conversion candidate or the geometric element data as the CAD conversion target may be displayed. Any method for allowing the geometric element data as the CAD conversion candidate and the geometric element data as the CAD conversion target to be clearly distinguished from each other can be widely adopted. Note that the first element display key 623 and the second element display key 624 may be a common key.

The selection field 625 is a selection field for selecting whether to receive designation of the number of significant digits at the time of rounding. The selection field 625 is provided with a check box such that the number of digits can be input to the number-of-significant-digits input section 627 when the check box is checked. Further, the unit input section 626 allows an input or selection of a unit. Note that the rounding unit 74 determines to execute rounding when the selection field 625 is checked.

Here, the number of significant digits refers to the minimum number of digits after the decimal point when a measurement value measured by mesh data is converted into CAD data. For example, when three digits after the decimal point is set as illustrated in FIG. 10, secondary geometric element data, subjected to rounding by the rounding unit 74 such that a characteristic value of geometric element data selected as a CAD conversion target becomes a numerical value having three digits after the decimal point, is converted into CAD data.

In general, a minimum unit is set in consideration of processing accuracy in the case of designing an article. Such a minimum unit is expressed by the number of digits after the decimal point or a minimum optical resolution (reference value) such as 0.05 mm, for example, as illustrated in FIG. 10. On the other hand, in a case where reverse engineering is performed to create a design drawing or a part drawing that can be used in the design drawing, the part drawing to be created is obtained by measuring an actual workpiece W, and thus, it is difficult to obtain data that matches a desired minimum unit. Therefore, reverse engineering is performed, and rounding is executed at the time of creating CAD data, so that it is possible to obtain the CAD data reflecting a design intention.

The OK key 628 is a key for establishing the above-described various inputs on the selection screen 62. The cancel key 629 is a key for discarding all of the above-described various inputs on the selection screen 62. When the reception unit 72 receives the operation of the OK key 628, the extraction unit 73 stores geometric element data displayed in the CAD conversion target display area 622 and a characteristic value associated with the geometric element data in the primary geometric element database Db1 as primary geometric element data.

Note that, in the geometric element data extraction process illustrated in FIG. 8, the extraction unit 73 collectively stores all pieces of the extracted geometric element data and characteristic values thereof in the primary geometric element database Db1 after the extraction of all pieces of geometric element data has been completed, but the embodiment is not limited thereto. For example, the extraction unit 73 may store geometric element data and a characteristic value thereof in the primary geometric element database Db1 every time the geometric element data is extracted from the mesh data. When the geometric element data extraction process illustrated in FIG. 8 is completed, the primary geometric element database Db1 storing all pieces of the extracted geometric element data and characteristic values thereof is stored in the storage unit 54.

As described above, the rounding unit 74 refers to the reference table Tb1 and the processing setting table Tb3 to executes rounding of the geometric element data included in the primary geometric element database Db1. Here, the reference table Tb1 and the processing setting table Tb3 will be described with reference to the drawings.

<Reference Table Tb1>

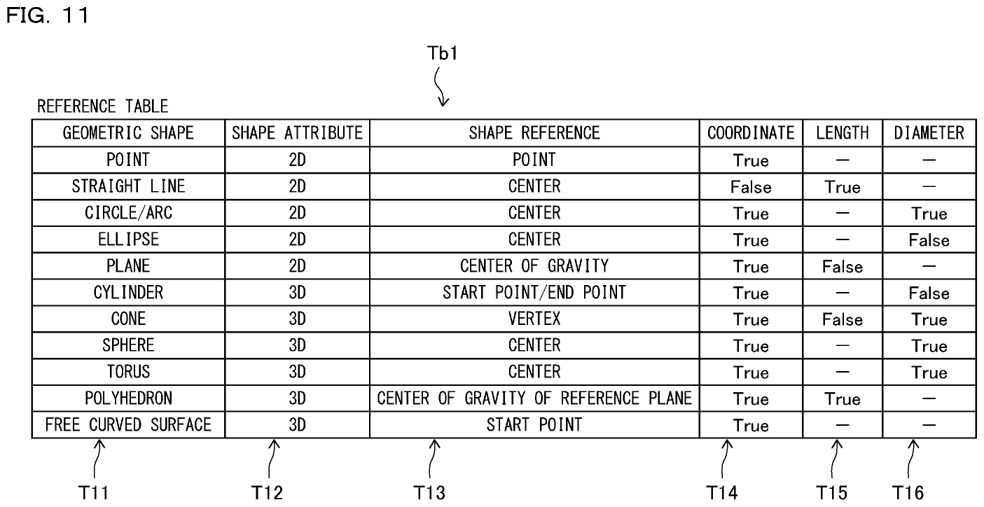

FIG. 11 is a schematic view illustrating an example of the reference table Tb1. The reference table Tb1 illustrated in FIG. 11 is a table indicating whether or not rounding can be performed on a characteristic portion such as a coordinate and a dimension of geometric element data. As illustrated in FIG. 11, the reference table Tb1 includes a shape name field T11, a shape attribute field T12, a shape reference field T13, a first instruction field T14, a second instruction field T15, and a third instruction field T16. The shape name field T11, the first instruction field T14, the second instruction field T15, and the third instruction field T16 correspond to the shape name field T01, the first characteristic field T02, the second characteristic field T03, and the third characteristic field T04 of the basic shape list table Tb0, respectively.

The shape name field T11 stores a general name of a basic shape that is a shape of a geometric element as a target to be subjected to rounding. The shape attribute field T12 indicates whether a reference shape is two-dimensional (“2D”) or three-dimensional (“3D”). Note that the shape attribute field T12 may be omitted in a case where shape attribute information is unnecessary.

The shape reference field T13 stores information on a portion serving as a reference for executing rounding for each basic shape. The portion serving as the reference is information of a portion (point) to serve as a reference at the time of specifying a basic shape. For example, when the reference shape is “Ellipse”, the portion serving as the reference is the center.

The first instruction field T14 corresponds to coordinate value information of the first characteristic field T02 of the basic shape list table Tb0, and stores information on whether to execute rounding on each coordinate value. Note that this “coordinate” indicates “Coordinate” of a point described in the shape reference field T13. In the reference table Tb1 illustrated in FIG. 11, the first instruction field T14 stores “True” in the case of executing rounding on “Coordinate value” and “False” in the other case.

The second instruction field T15 corresponds to dimensional values of the second characteristic field T03 of the basic shape list table Tb0, and stores information on whether to execute rounding on each of the dimensional values. Similarly to the first instruction field T14, the second instruction field T15 stores “True” and “False”. Further, in the case of a basic shape having no characteristic of “Length” as characteristics such as “Point”, “Ellipse”, or the like, the second instruction field T15 corresponding to the basic shape is indicated by “-”.

The third instruction field T16 corresponds to dimensional values of the third characteristic field T04 of the basic shape list table Tb0, and stores information on whether to execute rounding on each of the dimensional values. Similarly to the second instruction field T15, the third instruction field T16 stores “True”, “False”, and “-”. A third characteristic may be included only in a shape associated with a circle, such as “Ellipse”, “Sphere”, or “Cylinder”. Note that the reference table Tb1 may include characteristics of shapes other than a second characteristic and the third characteristic.

When a geometric element that can be extracted by the extraction unit 73 is added to the reference table Tb1, a basic shape corresponding to the added geometric element is added. Further, in the reference table Tb1, the setting of whether to execute (True) or not to execute (False) rounding may be set in advance, or may be changeable by the user without being limited thereto.

Although the first instruction field T14 of the reference table Tb1 is set as “Coordinate”, this coordinate can also be set in a more finely divided manner. For example, in the case of being indicated by the XYZ coordinate system, an individual setting of rounding of each axis may be allowed. For example, a setting may be made such that rounding is executed in the X-axis direction and the Y-axis direction, and rounding is not executed in the Z-axis direction.

### <Processing Setting Table Tb3>

Next, the processing setting table Tb3 will be described with reference to the drawing. FIG. 12 is a schematic view illustrating an example of the processing setting table Tb3. The processing setting table Tb3 illustrated in FIG. 12 includes an identification name field T31, an execution determination field T32, a reference field T33, a number-of-digits field T34, a reference value field T35, an allowable degree field T36, a tolerance determination field T37, a design value field T38, and a tolerance value field T39.

The identification name field T31 stores an identification name for individually specifying geometric element data extracted by the extraction unit 73.

The execution determination field T32 stores an execution determination value that is information on whether to execute rounding on the geometric element displayed in the identification name field T31. In the processing setting table Tb3 illustrated in FIG. 12, “True” is stored as the execution determination value for geometric element data to be subjected to rounding, and “False” is stored as the execution determination value for geometric element data not to be subjected to rounding. Note that the reference field T33, the number-of-digits field T34, the reference value field T35, the allowable degree field T36, and the tolerance field T37 corresponding to the geometric element not to be subjected to rounding are indicated by “-”.

The reference field T33 stores, as reference information, geometric element data or a reference coordinate system used as a reference in the case of performing positioning of geometric element data. The extracted geometric element data may be adopted as the reference information. In a case where the reference information is stored in the reference field T33, the rounding unit 74 positions a characteristic value of geometric element data to match the reference information. Further, in a case where the reference coordinate system is stored, the rounding unit 74 positions geometric element data so as to fit in the reference coordinate system. These types of positioning are examples of rounding. Note that the reference field T33 is indicated by “-” even in a case where coordinate rounding is “False” in the reference table Tb1.

The number-of-digits field T34 stores the number of significant digits at the time of executing rounding of geometric element data. Although details will be described later, the number of significant digits can be automatically set in the reverse engineering support apparatus 7, and can also be manually set by the user. As illustrated in FIG. 11, a numeral of the number of significant digits is stored in the number-of-digits field T34.

Note that there is a case where a “first number of significant digits” or a “second number of significant digits” is stored in the number-of-digits field T34. When the “first number of significant digits” or the “second number of significant digits” is stored, it means that the number of significant digits is set according to the number of significant digits of optical resolution of the three-dimensional measurement apparatus 1 or the display unit 51. The “first number of significant digits” is the number of significant digits of optical resolution when a dimension of the workpiece W is measured by the three-dimensional measurement apparatus 1. The “second number of significant digits” is the number of significant digits of a minimum unit (optical resolution or resolution) that enables display of an image on the display unit 51.

The reference value field T35 stores a reference value that is a value of a minimum unit used as a reference at the time of executing rounding of geometric element data. For example, in a case where the reference value is 0.05, secondary geometric element data after having been subjected to rounding is a numerical value that changes in units of 0.05. More specifically, the secondary geometric element data corrected based on the reference value is a numerical value such as 0.10, 0.15, 0.20, or 0.25. The allowable degree field T36 stores an allowable degree. In a case where rounding based on the allowable degree is not executed, the allowable degree field T36 is indicated by “-”.

The tolerance field T37 stores information on whether to perform a determination based on a design value and a tolerance of geometric element data. In the tolerance field T37, “True” is stored as information for instructing to perform determination based on a tolerance, and “False” is stored as information for instructing not to perform the determination based on a tolerance.

The design value field T38 stores a design value of geometric element data. Further, the tolerance field T39 stores a tolerance of geometric element data. Only when the tolerance field T37 is “True”, values are stored in the design value field T38 and the tolerance field T39. In other words, when the tolerance field T37 is “False”, the design value field T38 and the tolerance field T39 are indicated by “-”. Note that the design value and the tolerance may be manually input by the user, or for example, the setting unit 70 may acquire the design value and the tolerance from a database or the like provided outside the reverse engineering support apparatus 7.

<Processing Setting Table Creation Process>

In the reverse engineering support apparatus 7 according to the present embodiment, input of a condition for rounding is executed in a state in which a processing condition input screen 63 is displayed on the display unit 51 in the processing setting table creation process.

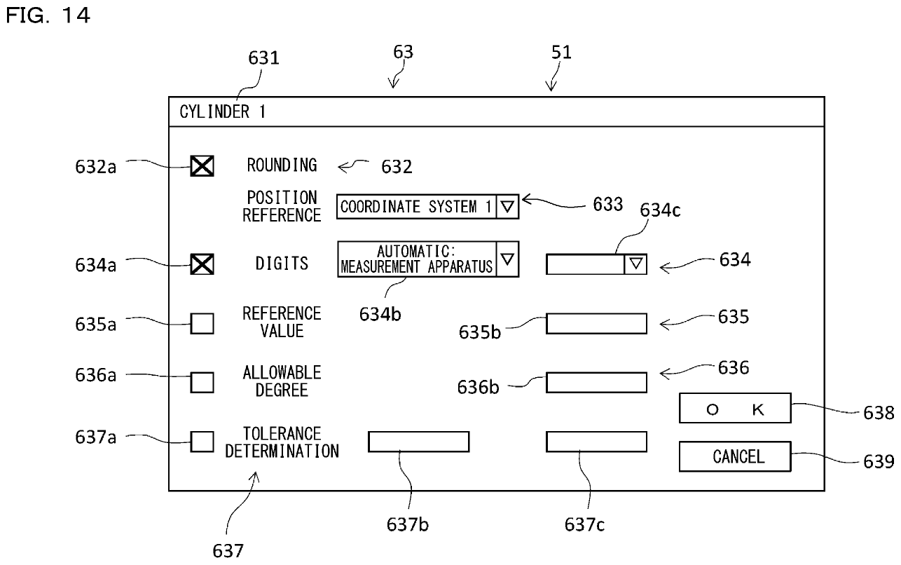

Here, the processing condition input screen 63 will be described with reference to the drawing. FIG. 14 is a schematic view illustrating an example of the processing condition input screen 63 displayed on the display unit 51. As illustrated in FIG. 14, the processing condition input screen 63 includes an identification name display section 631, a processing instruction input section 632, a reference input section 633, a number-of-digits input section 634, a reference value input section 635, an allowable degree input section 636, a tolerance determination instruction input section 637, an OK key 638, and a cancel key 639.

The identification name display section 631 displays an identification name of geometric element data for which a setting of rounding is to be made. Note that the identification name is the same as the identification name displayed in the CAD conversion target display area 622 on the selection screen 62. Note that the identification name may be changed while being displayed on the processing condition input screen 63. The geometric element data corresponding to the identification name displayed on the identification name display section 631 is sometimes referred to as selected geometric element data for convenience.

The processing instruction input section 632 receives a setting input as to whether to execute rounding. The processing instruction input section 632 is provided with a check box 632a at the left end, and a check state is switched based on reception of a user operation through the reception unit 72. When the check box 632a is checked, the rounding unit 74 executes rounding on a characteristic value of the geometric element data of the currently displayed identification name.

When the check box 632a of the processing instruction input section 632 is checked on the processing condition input screen 63, section of items arranged below the processing instruction input section 632 or input can be performed. Note that the “selection” refers to a case where a predetermined condition or setting value is selected. The “input” refers to a case where a setting value is directly input. Both the “selection” and the “input” are executed as the reception unit 72 receives an operation by the user.

In the processing condition input screen 63 illustrated in FIG. 14, the check box 632a of the processing instruction input section 632 is checked. Therefore, the items below the processing instruction input section 632 can be selected. For example, the display control unit 75 may determine the check state of the check box 632a and switch a display mode of the processing condition input screen 63 according to a result of the determination. In a case where the check box 632a of the processing instruction input section 632 is unchecked, items below the reference input section 633 on the processing condition input screen 63 may be made inoperable except for the OK key 638 and the cancel key 639. At this time, the display control unit 75 may display the respective items that are inoperable to be lighter in color or may hide all the items.

The reference input section 633 receives an input of designation of a reference at the time of executing rounding. As the reference designated here, a coordinate system defined in the three-dimensional measurement apparatus 1 and the reverse engineering support apparatus 7 or a coordinate system of the workpiece W may be used. In this case, the reference designated in the reference input section 633 may be input by being selected from information displayed in a pull-down menu.

Here, the reference displayed in the pull-down menu is a coordinate system or a position for performing positioning or serving as a reference of rounding in the rounding. As the reference, for example, as described above, the coordinate system (Coordinate system 1) of the three-dimensional measurement apparatus 1 can be exemplified. Further, in addition to this, geometric element data other than the selected geometric element data, for example, Cylinder 1 or the like can be exemplified. Note that, in a case where the geometric element data such as Cylinder 1 is designated, those having a coordinate value and a coordinate system in characteristic values of the designated geometric element data can be used as references. Further, in the case where the geometric element data such as Cylinder 1 is designated, the rounding unit 74 may execute rounding so as to obtain circumscribed or inscribed positioning with the selected geometric element data as a reference.

The number-of-digits input section 634 includes a check box 634a, a number-of-digits condition input box 634b, and a number-of-digits input box 634c. The check box 634a is configured similarly to the check box 632a of the processing instruction input section 632, and designates whether to execute rounding based on the number of significant digits. The number-of-digits condition input box 634b and the number-of-digits input box 634c may be operable only when the check box 632a is checked.

In a case where the rounding based on the number of significant digits is to be executed, the rounding unit 74 executes the rounding based on the “number of significant digits to be processed”. Details of the rounding based on the number of significant digits will be described later. In the number-of-digits condition input box 634b, a condition for setting the “number of significant digits to be processed” is input.

For example, as the “number of significant digits to be processed”, the rounding unit 74 sets a “set number of significant digits” which has been set with reference to the “first number of significant digits” that is the number of significant digits of the optical resolution of the three-dimensional measurement apparatus 1 or the “second number of significant digits” that is the number of significant digits of the optical resolution or resolution of the display unit 51. Further, there is also a case where the rounding unit 74 sets an “input number of significant digits” which has been input by the user as the “number of significant digits to be processed”.

Therefore, the number-of-digits condition input box 634b adopts a pull-down menu to enable selection of any one of the “first number of significant digits”, the “second number of significant digits”, and the “input number of significant digits”.

In a case where the “first number of significant digits” or the “second number of significant digits” is selected in the number-of-digits condition input box 634b, the rounding unit 74 sets the “set number of significant digits” based on the “first number of significant digits” or the “second number of significant digits”. That is, in a case where the number-of-digits condition input box 634b is set to the “first number of significant digits” or the “second number of significant digits”, the number of significant digits for executing the rounding, that is, the “number of significant digits to be processed” is automatically set for the user. Therefore, in order to clearly indicate that the rounding unit 74 automatically sets the number of significant digits, the display control unit 75 may clearly indicate an automatic state, such as “Automatic: First number of significant digits “or” Automatic: Second number of significant digits”, in the number-of-digits condition input box 634b. Further, in a case where the “input number of significant digits” input by the user is displayed, the display control unit 75 may display “Manual: Input number of significant digits” in the number-of-digits condition input box 634b to clearly indicate a “manual” state.

The optical resolution of the three-dimensional measurement apparatus 1 is finer than a minimum value (optical resolution) of a dimension used in a design drawing when a product is manufactured. Therefore, in a case where the reception unit 72 has received that the “first number of significant digits” is input in the number-of-digits condition input box 634b, the rounding unit 74 acquires the “first number of significant digits”, and can set the “number of significant digits to be processed” that is coarser, in other words, has a smaller number of significant digits than the “first number of significant digits”. For example, when the “first number of significant digits” is four digits after the decimal point (set to four digits), the rounding unit 74 can set the “set number of significant digits” to two digits after the decimal point (to two digits), which is smaller than four digits.

Note that the rounding unit 74 sets the number of significant digits, which is smaller by two digits than the “first number of significant digits”, as the “set number of significant digits” in the above example, but the embodiment is not limited thereto. For example, the rounding unit 74 may set the “set number of significant digits” that is smaller by one digit than the “first number of significant digits”, or may set the “set number of significant digits” that is smaller by three or more digits.

The resolution of the display unit 51 is often smaller than the minimum value of the dimension used in the design drawing. In a case where the reception unit 72 has received that the “second number of significant digits” is input in the number-of-digits condition input box 634b, the rounding unit 74 acquires the “second number of significant digits”, and can set the “set number of significant digits” that is coarser, in other words, has a smaller number of significant digits than the “second number of significant digits”. For example, when the “second number of significant digits” is three digits after the decimal point (set to three digits), the rounding unit 74 can set the “set number of significant digits” to two digits smaller than three digits.

Note that the rounding unit 74 sets the number of significant digits, which is smaller by one digit than the “second number of significant digits”, as the “set number of significant digits” in the above example, but the embodiment is not limited thereto. For example, the rounding unit 74 may set the “set number of significant digits” that is smaller by two or more digits than the “second number of significant digits”.

When receiving the input of the “first number of significant digits” or the “second number of significant digits” in the number-of-digits condition input box 634b, the reception unit 72 passes the “set number of significant digits” to the rounding unit 74. The rounding unit 74 sets the “number of significant digits to be processed” to the “set number of significant digits”.

The rounding unit 74 can execute rounding on a characteristic value of primary geometric element data with the “number of significant digits to be processed” that is coarser than the “first number of significant digits” or the “second number of significant digits”. The number of significant digits of a characteristic value of secondary geometric element data generated by rounding becomes the “number of significant digits to be processed”. Since the secondary geometric element data is generated in this manner, a minimum value (optical resolution) of the characteristic value of the secondary geometric element data can be set to optical resolution matching or approximated to the minimum value (optical resolution) of the dimension used in the design drawing.

Further, the number of significant digits can also be directly input by the user. When the “input number of significant digits” is input in the number-of-digits condition input box 634b, the number of digits can be input to the number-of-digits input box 634c. That is, the reception unit 72 may be allowed to receive an input of the number of digits into the number-of-digits input box 634c when receiving the input of the “input number of significant digits” into the number-of-digits condition input box 634b. At this time, the reception unit 72 receives the input of the “input number of significant digits” (numeral) in the number-of-digits input box 634c, and passes the “input number of significant digits” to the rounding unit 74. The rounding unit 74 sets the “number of significant digits to be processed” to the “input number of significant digits”.

When the user inputs the “input number of significant digits” into the number-of-digits input box 634c, there is a case where a larger number of digits is set in the “input number of significant digits” than that in the “first number of significant digits”. In this case, the “input number of significant digits” is not valid for the rounding. Therefore, when the rounding unit 74 compares the “first number of significant digits” with the “input number of significant digits” and determines that the “input number of significant digits” is larger than the “first number of significant digits”, the display control unit 75 may display a window for prompting the user to input the number of digits again. At this time, the display control unit 75 may perform display for suggesting that the number of digits is large.

The rounding unit 74 may call a numerical value stored in the storage unit 54 as the “first number of significant digits”, or may acquire the optical resolution from the three-dimensional measurement apparatus 1 (for example, the control board) and set the number of significant digits thereof. The rounding unit 74 may call a numerical value stored in the storage unit 54 as the “second number of significant digits”, or may acquire the optical resolution or the resolution from the display unit 51 and set the number of significant digits thereof.

The reference value input section 635 includes a check box 635a and a reference value input box 635b. The check box 635a has the same configuration as the check box 632a of the processing instruction input section 632. The check box 635a of the reference value input section 635 may be checked only when the check box 634a of the number-of-digits input section 634 is unchecked.

That is, the display control unit 75 can determine whether the reception unit 72 has received checking of the check box 634a, and switch a display mode of the reference value input section 635 according to a result of the determination. In this case, when the reception unit 72 receives the checking of the check box 634a, the display control unit 75 causes the display unit 51 to display the processing condition input screen 63 in which the reference value input section 635 is grayed out or the like. Note that the check box 634a of the number-of-digits input section 634 may be checked only when the check box 635a of the reference value input section 635 is unchecked. That is, the display control unit 75 can determine whether the reception unit 72 has received checking of the check box 635a, and switch a display mode of the number-of-digits input section 634 according to a result of the determination. In this case, when the reception unit 72 receives the checking of the check box 635a, the display control unit 75 causes the display unit 51 to display the processing condition input screen 63 in which the number-of-digits input section 634 is grayed out or the like.

A reference value is input to the reference value input box 635b by the user. The reference value is input to the reference value input box 635b through the reception unit 72. Note that the reference value input box 635b may be configured to receive a numerical value input through a keyboard, or may be configured to receive a numerical value selected from a pull-down menu. The reference value is a value indicating a minimum unit (optical resolution) of a dimension. Note that the rounding unit 74 may compare a minimum unit of a dimension of the mesh data acquired by the data acquisition unit 71 with the value received by the reception unit 72, and the display control unit 75 may display a window for prompting the user to input the reference value again when it is determined that the reference value smaller than the minimum unit of the mesh data acquired by the data acquisition unit 71 has been input.

The allowable degree input section 636 includes a check box 636a and an allowable degree input box 636b. The check box 636a has the same configuration as the check box 632a of the processing instruction input section 632. Input of an allowable degree into the allowable degree input box 636b may be possible only when the check box 636a is checked.

The allowable degree is a value representing a range in which rounding is executed used with a difference between a characteristic value of primary geometric element data and a characteristic value of geometric element data after rounding (hereinafter, referred to as secondary geometric element data). That is, the rounding may be stopped in a case where the amount of rounding at the time of creating the secondary geometric element data by rounding characteristic value of the primary geometric element data is larger than the allowable degree, and the rounding may be executed in a case where the amount of rounding is smaller than the allowable degree. In this way, a portion similar to a design value can be rounded to the design by executing the rounding while maintaining a defect, such as relatively large unevenness, in a portion having the defect in a measurement target object.

Alternatively, the rounding may be stopped in a case where the amount of rounding at the time of creating the secondary geometric element data by rounding characteristic value of the primary geometric element data is smaller than the allowable degree, and the rounding may be executed in a case where the amount of rounding is larger than the allowable degree. In this way, a portion deviating from a design value can be displayed in a simplified manner by executing the rounding while reproducing an actual fine shape of a measurement target object by maintaining a shape smaller than the allowable degree on the surface of the object measurement target. As such an allowable degree, a difference value between characteristic values before and after rounding may be defined, or a change rate of a characteristic value before and after rounding may be defined.

The tolerance determination instruction input section 637 includes a check box 637a, a design value input box 637b, and a tolerance input box 637c. The check box 637a has the same configuration as the check box 632a of the processing instruction input section 632. Input of a design value and a tolerance into the design value input box 637b and the tolerance input box 637c may be possible only when the check box 637a is checked.

In the design value input box 637b, a design value of geometric element data for which a setting of rounding is to be made can be manually input by the user. Similarly to the design value input box 637b, a tolerance can be manually input in the tolerance input box 637c by the user. Note that the design value and the tolerance are not limited to the manual input. For example, a separately provided design condition may be accessed, data of a design value and a tolerance may be received, and the data of the design value and the tolerance may be used. The data acquisition unit 71 may acquire the data of the design value and the tolerance from, for example, an external storage, a cloud, or the like. Specific description of the rounding based on the design value and the tolerance will be given in third rounding to be described later.

The OK key 638 and the cancel key 639 respectively instruct fixing and discarding of an input of the processing condition input screen 63. That is, when the reception unit 72 detects an operation input of the OK key 638, the rounding unit 74 determines that an input of a processing condition has been completed. Further, when the reception unit 72 detects an operation input of the cancel key 639, the display control unit 75 temporarily closes the processing condition input screen 63. At this time, the display control unit 75 may cause the display unit 51 to display the initial display of the processing condition input screen 63 (display in a state in which no input has been executed for various settings).

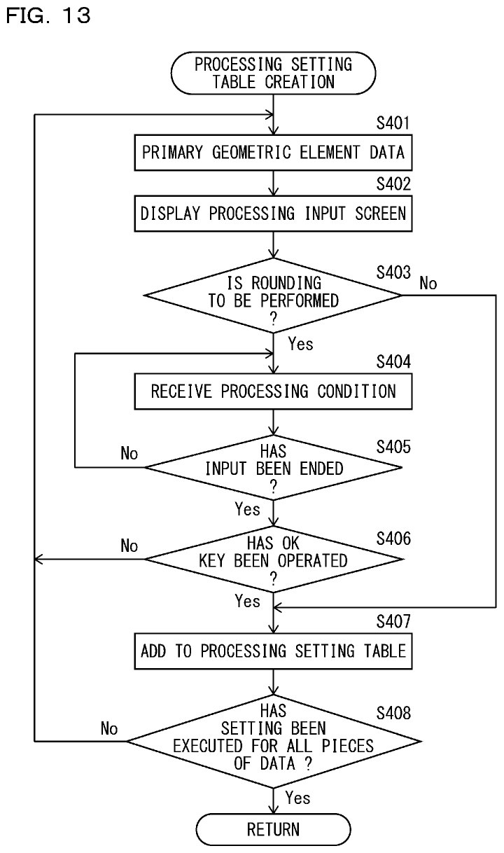

An operation of the reverse engineering support apparatus 7 in the processing setting table creation process described above will be described with reference to the drawing. FIG. 13 is a flowchart illustrating the operation in the processing setting table creation process. Pieces of geometric element data extracted in the geometric element data extraction process illustrated in FIG. 8 are stored in the primary geometric element database Db1 of the storage unit 54 together with identification names thereof. The processing setting table Tb3 is created by the setting unit 70.

In Step S401, the setting unit 70 calls geometric element data from the primary geometric element database Db1 of the storage unit 54. Here, a condition for rounding is set for each piece of the geometric element data and stored in the processing setting table Tb3. Therefore, in Step S401, only an identification name of the geometric element data may be called, or a characteristic value may also be called together.

In the next Step S402, the display control unit 75 displays the processing condition input screen 63 (see FIG. 14) of one identification name included in the primary geometric element database Db1 on the display unit 51. Note that the order of display of the processing condition input screen 63 may be, for example, the described order in the primary geometric element database Db1, in other words, the stored order, but is not limited thereto. For example, a predetermined order based on shapes or positions may also be used.

In Step S403, the setting unit 70 determines whether to execute rounding on the currently selected geometric element. Specifically, when the reception unit 72 receives an operation input of the OK key 638 with the check box 632a of the processing instruction input section 632 being unchecked on the processing condition input screen 63, the setting unit 70 determines not to execute rounding on the selected geometric element data.

In a case where it is determined not to execute rounding on the currently selected geometric element data (No in Step S403), the flow proceeds to Step S407. In Step S407, the setting unit 70 stores, in the processing setting table Tb3, the identification name of the geometric element for which input of a processing condition is currently executed and data indicating that rounding is not to be executed in the execution determination field T32.

In a case where it is determined to execute rounding on the currently selected geometric element data (Yes in Step S403), the flow proceeds to Step S404. Note that when the reception unit 72 receives checking of the check box 632a of the processing instruction input section 632 on the processing condition input screen 63, the setting unit 70 determines to execute rounding on the selected geometric element data.

In Step S404, the reception unit 72 receives an input of a condition into the processing condition input screen 63. As described above, in the case where the execution of rounding is selected, the input of necessary data among the reference coordinate system, the number of digits, the reference value, the allowable degree, and the tolerance determination is received. That is, the reception unit 72 receives at least one data input of the reference input section 633, the number-of-digits input section 634, the reference value input section 635, the allowable degree input section 636, and the tolerance determination instruction input section 637. In Step S405, the setting unit 70 determines whether the input of a condition for rounding has been completed. The determination as to whether the input of a condition for rounding has been completed is made by the reception unit 72 depending on whether the OK key 638 or the cancel key 639 has been operated.

When the reception unit 72 receives an operation input of the OK key 638 or the cancel key 639, the flow proceeds to Step S406. In Step S406, the reception unit 72 determines whether the operation of the OK key 638 is received. In a case where the reception unit 72 has received the operation input of the cancel key 639 (No in Step S406), the display control unit 75 temporarily erases the processing condition input screen 63 currently displayed on the display unit 51, and returns to Step S402. In Step S402, the display control unit 75 displays the processing condition input screen 63 again for input of a condition of rounding with respect to the current geometric element.

In a case where the reception unit 72 has received the operation input of the OK key 638 (Yes in Step S406), the flow proceeds to Step S407. In Step S407, the setting unit 70 stores the input of the condition for rounding on the processing condition input screen 63 received by the reception unit 72 in the processing setting table Tb3 together with the identification name. Then, the flow proceeds to Step S408.

In Step S408, the setting unit 70 determines whether a condition for rounding has been set for all pieces of the geometric element data stored in the primary geometric element database Db1. Specifically, the setting unit 70 is executed by comparing the identification names stored in the primary geometric element database Db1 with the identification names stored in the processing setting table Tb3.

When the setting unit 70 determines that the primary geometric element database Db1 includes geometric element data for which a condition for rounding has not been set (No in Step S408), the flow returns to Step S402, the display control unit 75 displays the processing condition input screen 63 for a condition for rounding of the next geometric element data on the display unit 51, and the reception unit 72 receives an input operation on the processing condition input screen 63 by the user.

In a case where a condition for rounding has been set for all pieces of the geometric element data included in the primary geometric element database Db1 (Yes in Step S408), the setting unit 70 returns to Step S206 illustrated in FIG. 5. As a result, the processing setting table Tb3 is completed.

In the processing table creation process of the present embodiment, conditions for rounding in the case of executing the rounding including information on whether to execute the rounding with respect to pieces of the geometric element data stored in the primary geometric element database Db1 are sequentially stored in the processing setting table Tb3. However, the embodiment is not limited thereto, and for example, rounding for all pieces of the geometric element data stored in the primary geometric element database Db1 may be buffered, and the rounding information for all pieces of the geometric element data may be finally stored in the processing setting table Tb3.

<First Rounding>

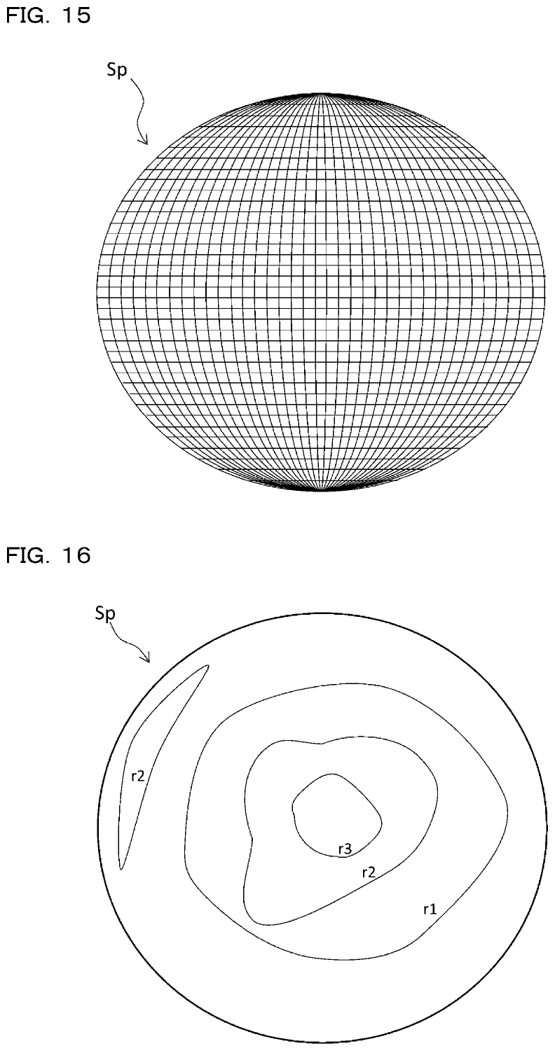

Here, rounding will be described. FIG. 15 is mesh data of a sphere Sp measured by the three-dimensional measurement apparatus 1. FIG. 16 is a schematic view illustrating the distribution of radii of the spheres Sp illustrated in FIG. 15. FIG. 16 illustrates a portion having the same radius with a continuous line.

The three-dimensional measurement apparatus 1 irradiates the workpiece W with measurement light, measures a surface shape of the workpiece W from a captured image of the workpiece W, and creates mesh data. In the mesh data that looks like a sphere, variations in a radius, such as r1, r2, and r3, actually exist as illustrated in FIG. 16 even if the mesh data looks like the sphere. That is, the shape of the sphere Sp illustrated in FIG. 16 is not exactly the sphere but is a shape similar to the sphere since there are variations in the radius.

Examples of a cause of the variations in the radius of the sphere Sp include a manufacturing error, wear due to use, deformation, and the like. The extraction unit 73 acquires characteristic values, such as coordinate values and dimensional values, of the sphere from the mesh data including such variations in the radius using the above-described algorithm. Therefore, the characteristic value of the sphere is data having a minor fraction (hereinafter, referred to as “data having a fraction”).

As described above, the design drawing includes the design intention of the user. However, the mesh data obtained by the three-dimensional measurement apparatus 1 does not necessarily reflect the design intention of the user. That is, primary geometric element data is data having a fraction. Therefore, the rounding unit 74 creates secondary geometric element data obtained by executing rounding, such as rounding-off, rounding-down, and rounding-up, a predetermined characteristic value of the primary geometric element data, thereby acquiring the geometric element data reflecting the design intention of the user.

### <First Rounding (Rounding Based on Number of Significant Digits)>

Next, an operation of rounding will be described with reference to a flowchart illustrated in FIG. 17. In “first rounding” of this example, a method of executing rounding based on the number of significant digits will be described as an example.

In Step S501, the rounding unit 74 calls one piece of geometric element data from the primary geometric element database Db1. In Step S502, the rounding unit 74 refers to the processing setting table Tb3 and determines whether the one piece of primary geometric element data called in Step S501 is a rounding target. Here, the rounding unit 74 determines whether the one piece of primary geometric element data called in Step S501 is a rounding target based on information described in the execution determination field T32 of the processing setting table Tb3.

In a case where the one primary geometric element data is not a rounding target in Step S502 (No in Step S502), the flow proceeds to Step S511.

In a case where the first primary geometric element data is a rounding target in Step S502 (Yes in Step S502), the flow proceeds to Step S503. In Step S503, the rounding unit 74 refers to the reference table Tb1. Then, the rounding unit 74 acquires a characteristic value to be subjected to rounding of primary geometric element data called in Step S501 based on the reference table Tb1. Note that the rounding unit 74 refers to the first instruction field T14, the second instruction field T15, and the third instruction field T16 of the reference table Tb illustrated in FIG. 11, specifies the characteristic value to be subjected to rounding, and calls the corresponding characteristic value from the primary geometric element database Db1.

Next, in Step S504, the rounding unit 74 calls the number of significant digits stored in the number-of-digits field of the processing setting table Tb3 and sets the number as the number of significant digits to be processed. The number of significant digits to be processed is the number of significant digits at the time of executing rounding. Then, the flow proceeds to Step S505.

In Step S505, the rounding unit 74 executes rounding on the characteristic value of the primary geometric element data to generate a characteristic value of the secondary geometric element data. Here, details of the rounding will be described. First, rounding in a case where the characteristic value is a dimensional value such as a length or a diameter will be described. Here, it is assumed that rounding-off is executed as rounding of a numerical value. Note that processing in rounding-down or rounding-up differs from that in the rounding-off, but has substantially the same contents.

For example, it is assumed that the characteristic value is a numerical value up to five digits after the decimal point. Assuming that the number of significant digits to be processed is set to two digits after the decimal point, the characteristic value of the secondary geometric element data is generated by rounding off the third digit after the decimal point of the characteristic value. In this manner, even when the number of digits of the characteristic value of the primary geometric element data is different from the number of digits based on the design intention of the user, it is possible to generate the secondary geometric element data having the number of significant digits according to the design intention of the user or the number of significant digits close to the design intention of the user.

Note that, in a case where the characteristic value is a coordinate value and rounding is executed on the coordinate value, the generation of the secondary geometric element data is achieved by rounding off each coordinate value based on the designated number of significant digits. Note that, in a case where a geometric element has a two-dimensional shape such as a rectangle or a three-dimensional shape of a polyhedron, the generation of the secondary geometric element data may be achieved by rotating the geometric element based on a reference coordinate system and then performing translation such that coordinates of vertexes and the center of gravity of the geometric element are arranged on grid points. Note that the above-described rounding with respect to a coordinate value is an example, and the embodiment is not limited thereto. Other processing may be executed.

In the next Step S506, the determination unit 76 determines whether to execute a validity determination of rounding based on an allowable degree. Note that, in a case where there is a numerical value of the allowable degree in the allowable degree field T36 of the processing setting table Tb3, the determination unit 76 determines to execute the validity determination of rounding based on an allowable degree.

In a case where the determination unit 76 determines not to execute the validity determination of rounding based on an allowable degree (No in Step S506), the flow proceeds to Step S509. In Step S509, the rounding unit 74 stores the secondary geometric element data obtained by rounding in the secondary geometric element database Db2 of the storage unit 54. In a case where the determination unit 76 determines to execute the validity determination of rounding (Yes in Step S506), the flow proceeds to Step S507.

In Step S507, the determination unit 76 computes a comparison value for comparing the secondary geometric element data with the primary geometric element data. Examples of the computation of the comparison value can include a calculation of a difference between characteristic values to be subjected to rounding of the secondary geometric element data and the primary geometric element data. Further, in addition to this, a difference between physical quantities depending on shapes such as lengths, areas, and volumes of the primary geometric element data and the secondary geometric element data may be used as the comparison value. Further, a ratio between the primary geometric element data and the secondary geometric element data may be used as the comparison value although the difference is obtained as the comparison value in the above description. After the determination unit 76 calculates the comparison value in Step S507, the flow proceeds to Step S508.

In Step S508, the determination unit 76 determines whether the comparison value is less than the allowable degree. In a case where the determination unit 76 determines that the comparison value is less than the allowable degree (Yes in Step S508), the flow proceeds to Step S509. In Step S509, the rounding unit 74 stores the secondary geometric element data generated by rounding in the secondary geometric element database Db2. Then, the flow proceeds to Step S511.

Further, in a case where the determination unit 76 determines that the comparison value exceeds the allowable degree in Step S508 (No in Step S508), the flow proceeds to Step S510. In Step S510, the rounding unit 74 discards the secondary geometric element data generated by rounding based on the determination result of the determination unit 76 in Step S508. When more specifically describing Steps S508 and S510, the determination unit 76 determines that the generated secondary geometric element data is not suitable for the design intention of the user. The rounding unit 74 does not store one piece of the secondary geometric element data obtained by rounding in the secondary geometric element database Db2 and discards the data.

Further, in Step S510, the display control unit 75 may generate a display screen showing information indicating that rounding is not suitable and display the display screen on the display unit 51.

Then, in Step S511 following Step S509 or Step S510, the rounding unit 74 determines whether the determination regarding the necessity of execution of rounding has been performed for all pieces of the geometric element data stored in the primary geometric element database Db1. In a case where the determination regarding the necessity of execution of rounding has not been performed for all pieces of the geometric element data (No in Step S511), the flow returns to Step S501, and the next one piece of geometric element data and a characteristic value thereof in the primary geometric element database Db1 are called.

Further, in a case where the rounding unit 74 determines the necessity of execution of rounding has been performed for all pieces of the geometric element data stored in the primary geometric element database Db1 (Yes in Step S511), the flow returns to Step S207 of FIG. 5.

In this way, the rounding unit 74 executes rounding on the characteristic values of all pieces of the primary geometric element data stored in the primary geometric element database Db1 of the storage unit 54 as necessary. Then, the rounding unit 74 executes rounding on the characteristic values of pieces of the primary geometric element data to generate pieces of the secondary geometric element data, and stores pieces of the secondary geometric element data in the secondary geometric element database Db2 of the storage unit 54.

In Step S207 of FIG. 5, the conversion unit 77 converts at least one of the primary geometric element data stored in the primary geometric element database Db1 or the secondary geometric data stored in the secondary geometric element database Db2 stored in the storage unit 54 into CAD data.

In the reverse engineering support apparatus 7, the primary geometric element database Db1 and the secondary geometric element database Db2 may be independently stored in the storage unit 54. As a result, the reverse engineering support apparatus 7 can generate the secondary geometric element data obtained by executing rounding on the primary geometric element data extracted from the mesh data while storing the primary geometric element data.

Then, in Step S508, the determination unit 76 determines that suitable rounding has been executed when the comparison value is less than the allowable degree. As a result, in a case where the secondary geometric element data generated by rounding is not greatly deviated from the primary geometric element data, the secondary geometric element data is subjected to the CAD conversion. Therefore, secondary CAD data obtained by converting the secondary geometric element data can be used as data for designing another member.

On the other hand, in a case where the comparison value is equal to or more than the allowable degree, the secondary geometric element data obtained by executing rounding may be left.

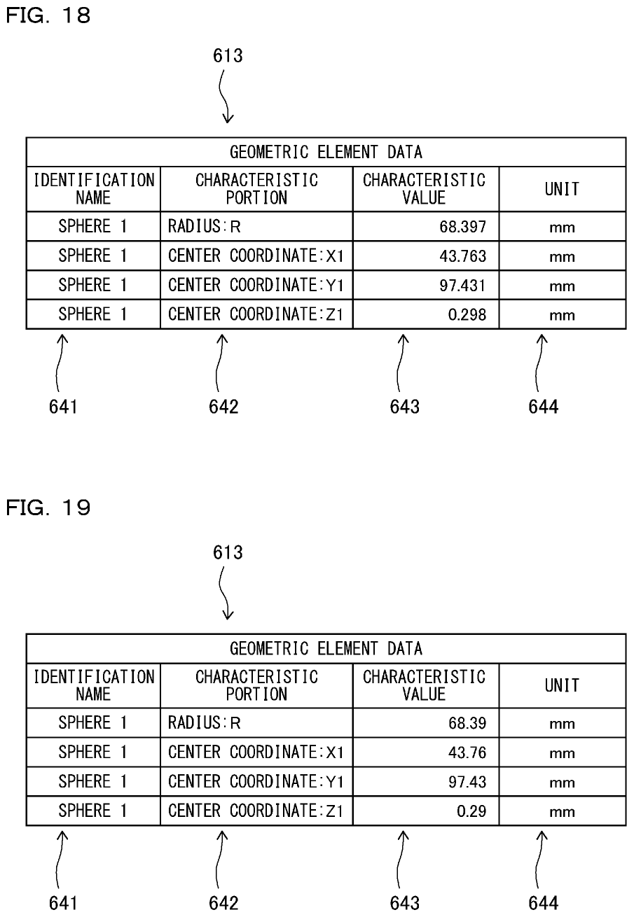

Here, specific examples of the rounding based on the number of significant digits will be described with reference to the drawings. FIG. 18 is a view for describing primary geometric element data of an example. FIG. 19 is a view for describing secondary geometric element data obtained by rounding the primary geometric element data illustrated in FIG. 18. As illustrated in FIG. 18, here, “Sphere 1” will be described as an example of a geometric element.

Geometric element data illustrated in FIGS. 18 and 19 is displayed similarly to the geometric element data display area 614 of the three-dimensional display screen 61 illustrated in FIG. 9. Therefore, the geometric element data display area 614 will be described here. As illustrated in FIG. 18, the geometric element data display area 614 is a table, and includes an identification name field 641, a characteristic portion field 642, a characteristic value field 643, and a unit field 644.

An identification name for individually identifying the geometric element data is stored in the identification name field 641. Here, “Sphere 1” is stored. In the characteristic portion field 642, characteristic portions for specifying the geometric element are described according to the description of the basic shape list table Tb0 illustrated in FIG. 3. Here, a radius R, a center coordinate X1, a center coordinate Y1, and a center coordinate Z1 are described. The characteristic value field 643 stores characteristic values called from the primary geometric element database Db1. A unit of data stored in the characteristic value field 643 is displayed in the unit field 644. Here, millimeter is displayed.

As described above, the rounding unit 74 acquires the number of significant digits to be processed at the time of executing rounding from the number-of-significant-digits field T34 of the processing setting table Tb3. In the processing setting table Tb3 illustrated in FIG. 12, the number of significant digits to be processed of “Sphere 1” is two digits.

The rounding unit 74 first confirms the execution determination field T32 of “Sphere 1” in the processing setting table Tb3 illustrated in FIG. 12 and determines whether to execute rounding. Then, when the rounding unit 74 confirms that rounding is to be executed, the rounding unit 74 refers to the reference table Tb1 illustrated in FIG. 11 and confirms which characteristic value of “Sphere 1” is to be subjected to rounding. In “Sphere” in the reference table Tb1 illustrated in FIG. 11, a coordinate and a diameter are characteristic values to be subjected to rounding, and a length is not to be subjected to rounding. Therefore, rounding is executed on the center coordinate X1, the center coordinate Y1, the center coordinate X1, and the radius R among the characteristic values illustrated in FIG. 18.

As illustrated in FIG. 18, the characteristic values to be subjected to rounding of “Sphere 1” are the radius R of 68.397, the center coordinate X1 of 43.763, the center coordinate Y1 of 97.431, and the center coordinate Z1 of 0.298. Rounding was executed on these numerical values with the number of significant digits being two digits after the decimal point. Here, as rounding of a coordinate value, rounding-down of numerals in and after the designated number of digits (three digits after the decimal point) was executed. However, the rounding of a coordinate value is not limited thereto, and rounding-off based on the designated number of digits, round-up with the designated number of digits, or the like may be executed.

As illustrated in FIG. 19, secondary geometric element data having the radius R of 68.39, the center coordinate X1 of 43.76, the center coordinate Y1 of 97.43, and the center coordinate Z1 of 0.29 is generated as the rounding unit 74 executes the rounding. It can be said that the secondary geometric element data has values reflecting the design intention more since the rounding has been executed with the number of significant digits that is coarser than the number of significant digits of the primary geometric element data and reflects the design intention of the user. In this manner, in the case of executing rounding, the characteristic value included in the geometric element data is subjected to the rounding with reference to the reference table Tb1. Note that the secondary geometric element data generated by rounding in the rounding unit 74 is stored in the secondary geometric element database Db2 illustrated in FIG. 7 in association with the identification name.

### <Second Rounding (Rounding Based on Reference Value)>

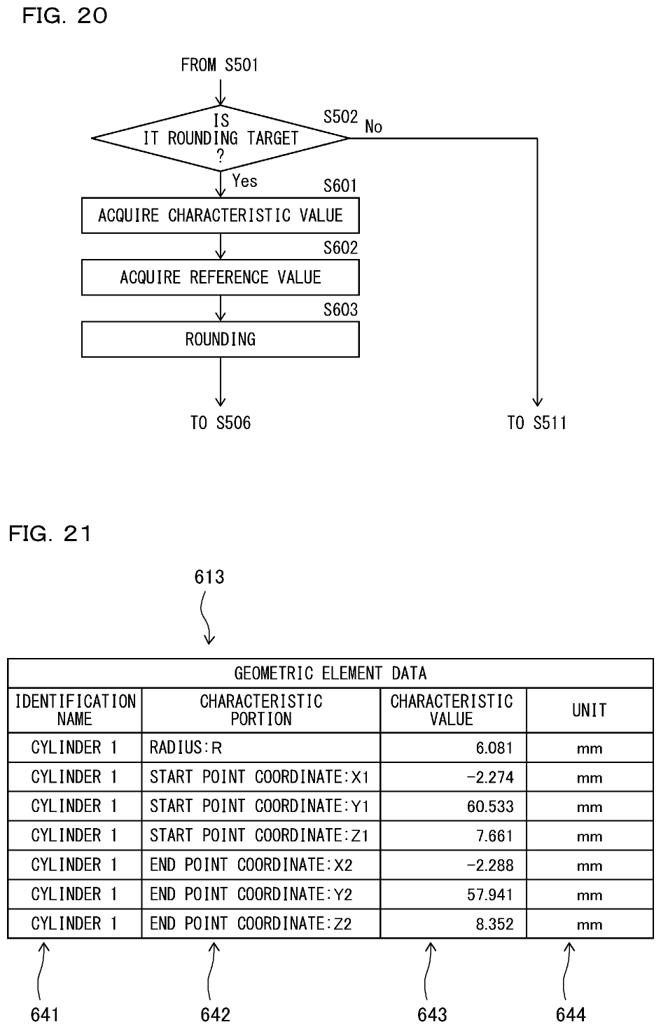

Another example of rounding will be described with reference to the drawing. FIG. 20 is a flowchart illustrating a part of another example of rounding. The flowchart illustrated in FIG. 20 is a process that replaces Steps S502 to S505 of the flowchart illustrated in FIG. 17. The flowchart illustrated in FIG. 20 is the process that starts after Step S502 illustrated in FIG. 17 and is connected to Step S506 or Step S511. Second rounding is rounding using a reference value.

As illustrated in FIG. 20, in Step S502, the rounding unit 74 determines whether to execute rounding. When the rounding unit 74 determines to execute rounding (Yes in Step S502), the flow proceeds to Step S601, and the rounding unit 74 refers to the reference table Tb1 to acquire a characteristic value to be subjected to rounding from geometric element data. Since the processing of Step S601 is the same as the processing of Step S503, details thereof will be omitted. Then, the flow proceeds to Step S602, and the rounding unit 74 acquires a reference value of rounding from the reference value field T35 of the processing setting table Tb3. Then, the flow proceeds to Step S603, and the rounding unit 74 executes rounding.

The rounding unit 74 executes rounding such that the acquired reference value becomes a minimum unit of the rounded geometric element data. For example, in a case where the reference value is 0.5, the rounding is executed such that rounded numerical values become, for example, numerical values in increments of 0.5 such as (0.5, 2.5, 4.0, and 5.0). More specifically, with the reference value being 0.5, a numerical value at the first decimal place being (0.0, 0.1, or 0.2) is rounded be 0.0. Further, (0.3, 0.4.0.5, 0.6, or 0.7) is rounded to be 0.5. Further, (0.8 or 0.9) is rounded up to be 1.0. A correction method is an example, and rounding may be executed according to different laws even if the same reference value is used. In addition to these, any processing method of processing the geometric element data such that the reference value becomes the minimum unit can be widely adopted. After the rounding, the flow proceeds to Step S506.

In a case where rounding based on a reference value is executed, the rounding unit 74 processes a characteristic value of the geometric element data such that the minimum unit is the reference value. At this time, a difference before and after the rounding of the characteristic value is smaller than the reference value. When a determination is made by comparing a difference value between primary geometric element data and secondary geometric element data with an allowable degree, the allowable degree may be set to a value smaller than the reference value. Note that, on the selection screen 511, when the determination unit 76 determines that the allowable degree received by the reception unit 72 is larger than the reference value, a notification that the allowable degree is not suitable may be issued.

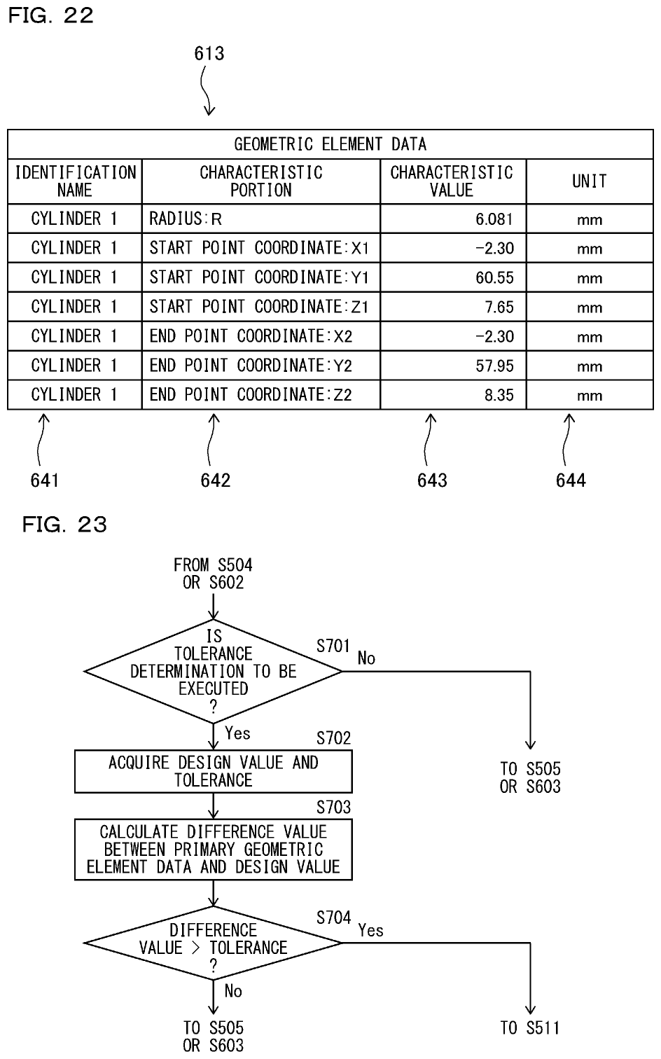

Here, specific examples of the rounding based on the reference value will be described with reference to the drawings. FIG. 21 is a schematic view of primary geometric element data of an example. FIG. 22 is a schematic view of secondary geometric element data obtained by rounding primary geometric element data of a geometric element illustrated in FIG. 21. As illustrated in FIG. 21, the geometric element is Cylinder 1.

The geometric element data display area 614 illustrated in FIGS. 21 and 22 is the same as the geometric element data display area 614 illustrated in FIGS. 18 and 19. Therefore, substantially the same portions will be denoted by the same reference signs, and the detailed description of the same portions will be omitted.

The rounding unit 74 first specifies one piece of geometric element data from among pieces of the geometric element data extracted by the extraction unit 73. Then, the rounding unit 74 determines whether to execute rounding on one piece of the geometric element data specified with reference to the processing setting table Tb3. In the processing setting table Tb3, the execution determination field T32 of “Cylinder 1” which is an example of the identified one piece of geometric element data. is “True”. Therefore, the rounding unit 74 executes rounding on the identified one piece of geometric element data. Then, the rounding unit 74 refers to the reference table Tb1 and specifies a coordinate value as a characteristic value to be subjected to rounding.

Further, the rounding unit 74 refers to the reference value field T35 of the processing setting table Tb3 to acquire a reference value. Since the reference value of the “Cylinder 1” is “0.05”, the rounding unit 74 executes rounding on each characteristic value of the start point coordinate X1, the start point coordinate Y1, the start point coordinate Z1, the end point coordinate X2, the end point coordinate Y2, and the end point coordinate Z2 such that a minimum unit of a dimension becomes 0.05.

Specifically, as illustrated in FIG. 21, the start point coordinate X1 of −2.274, the start point coordinate Y1 of 60.533, the start point coordinate Z1 of 7.661, the end point coordinate X2 of −2.288, the end point coordinate Y2 of 57.941, and the end point coordinate Z2 of 8.352 are given. Since the reference value is “0.05”, when a numeral at the second decimal place is “0”, “1”, and “2”, the numeral of the second decimal place is set to “0” with increments of 0.05. When a numeral of the second decimal place is “3”, “4”, “5”, “6”, or “7”, the numeral at the second decimal place is set to “5”. When a numeral at the second decimal place is “8” or “9”, a numeral at the first decimal place is rounded up, and a numeral at the second decimal place is set to “0”.

In view of the above, the rounding unit 74 executes rounding to obtain the start point coordinate X1 of −2.30, the start point coordinate Y1 of 60.55, the start point coordinate Z1 of 7.65, the end point coordinate X2 of −2.30, the end point coordinate Y2 of 57.95, and the end point coordinate Z2 of 8.35 (see FIG. 22).

The rounding based on the reference value is particularly effective in a case where the design intention is expressed by not the number of digits after the decimal point but the reference value such as 0.01 or 0.05. In such a case, the geometric element data extracted by the extraction unit can be converted into CAD data while reflecting the design intention.

In the “first rounding”, the case where the rounding unit 74 sets the number of significant digits to be processed that is coarser than the first number of significant digits, which is the optical resolution of the three-dimensional measurement apparatus 1, or the second number of significant digits, which is the number of significant digits of the resolution (optical resolution) of the display unit 51, and executes the rounding has been described. Further, in the “second rounding”, the case where the rounding unit 74 executes the rounding based on the reference value set by the user has been described. In the above embodiment, the “first rounding” and the “second rounding” are described as separate processes, but the embodiment is not limited thereto. These processes may be executed as a series of processes.

Further, the rounding unit 74 may selectively execute one of the rounding based on the number of significant digits and the rounding based on the reference value on the basis of selection by the user or on the basis of selection by the rounding unit 74 or the like.

### <Third Rounding (Determination Based on Tolerance)>

Another example of rounding will be described with reference to the drawing. FIG. 23 is a flowchart illustrating a part of still another example of rounding. In third rounding, the necessity of rounding is determined based on a tolerance. The flowchart illustrated in FIG. 23 is a flowchart for calculating, in a case where one piece of primary geometric element data is a target of rounding by the rounding unit 74, a difference value between the target primary geometric element data and a design value and determining whether to execute the rounding based on the calculated difference value.

For example, if CAD data obtained by converting secondary geometric element data, obtained by rounding primary geometric element data, can be directly used for a design drawing, the time and effort for creating the CAD data can be saved.

Meanwhile, for example, there is a case where a difference between the original shape from which geometric element data of the workpiece W has been extracted and a design value deviate from a tolerance range due to a problem in manufacturing, wear due to use, damage, or the like. When the difference between the workpiece W and the design value deviates from the tolerance range, there is a high possibility that a defect is generated in the workpiece W instead of a manufacturing error or the like. When the rounding is executed in a case where the difference value between the primary geometric element data and the design value is smaller than the tolerance, the manufacturing error or the like of the workpiece W can be rounded, and a shape of a defective portion generated in the workpiece W can be maintained as it is.

Further, there is a case where it is desired to confirm a minute shape of the surface of the workpiece W and it is sufficient to roughly confirm a portion having a change exceeding the tolerance. In such a case, the rounding is executed when the difference value between the primary geometric element data and the design value is larger than the tolerance, so that it is possible to simplify a shape of a portion where the user's interest is low while maintaining a shape of a portion where the user's interest is high.

Therefore, in the “third rounding”, the rounding unit 74 determines whether to execute rounding depending on whether the primary geometric element data is within the tolerance range of the design value before executing the rounding. Details of such a tolerance determination will be described below.

In Step S701, the determination unit 76 determines whether to execute the tolerance determination. Note that the determination unit 76 determines whether to execute the tolerance determination by referring to the tolerance field T37 of the processing setting table Tb3. More specifically, in a case where “True” is stored as a tolerance determination value in the tolerance field T37, the determination unit 76 determines to execute the tolerance determination.

Here, the tolerance determination is executed for geometric element data for which rounding is to be executed. Therefore, Step S701 is executed after the rounding unit 74 acquires the number of significant digits to be processed in Step S504 of the flowchart illustrated in FIG. 17 or after the rounding unit 74 acquires the reference value in Step S603 of the flowchart illustrated in FIG. 20. That is, the determination in Step S701 is executed immediately before the rounding unit 74 executes the rounding. Note that Step S701 only needs to be performed before the execution of rounding, and is not necessarily performed after Step S504 or Step S603.

In a case where the determination unit 76 determines not to execute the tolerance determination (No in Step S701), the flow proceeds to Step S505 or Step S603. In a case where the determination unit 76 determines to execute the tolerance determination (Yes in Step S701), the flow proceeds to Step S702. In Step S702, the determination unit 76 refers to the processing setting table Tb3 to acquire a design value and a tolerance corresponding to the primary geometric element data as the rounding target. More specifically, the determination unit 76 acquires the design value and the tolerance stored in the design value field T38 and the tolerance field T39 of the processing setting table Tb3. Further, a design value and a tolerance may be stored in a database provided separately from the processing setting table Tb3 in association with each piece of primary geometric element data, and the determination unit 76 may acquire the design value and the tolerance by referring to the database. Further, the determination unit 76 may acquire a design value and a tolerance stored in a cloud connected to the Internet or the like.

For example, in a case where the workpiece W is an industrial product, a general-purpose product whose standard has been fixed by an industrial standard or the like defined by a public institution is often used for a pipe, a steel material, a steel plate, a bearing, or the like. When such a general-purpose product is used, there is a case where a design value and a tolerance are disclosed in a cloud connected to the Internet by an organization that has defined the industrial standard. In such a case, the determination unit 76 may acquire the design value and the tolerance from the cloud.

After the determination unit 76 acquires the design value and the tolerance in Step S702, the flow proceeds to Step S703. In Step S703, the determination unit 76 calculates a difference value between the current primary geometric element data and the design value. More specifically, the determination unit 76 obtains a difference value between a characteristic value to be subjected to the rounding of the primary geometric element data and the design value corresponding to the characteristic value.

In Step S704, the determination unit 76 determines whether the difference value is larger than the tolerance. In a case where the determination unit 76 determines that the difference value is equal to or smaller than the tolerance (No in Step S704), the determination unit 76 determines that a shape indicated by the primary geometric element data of the workpiece W matches the design value (shape desired by the user). In other words, it is determined that CAD data reflecting the design intention of the user can be generated by performing conversion of the difference-processed primary geometric element data. Then, the flow proceeds to Step S505 or Step S603 to execute the rounding.

On the other hand, in a case where the determination unit 76 determines that the difference value is larger than the tolerance (Yes in Step S704), the flow proceeds to Step S511. Here, a case in which the rounding is executed on the primary geometric element data when the determination unit 76 determines that the difference value is equal to or smaller than the tolerance has been described, but the embodiment is not limited thereto. As described above, the rounding may be executed on the primary geometric element data when the determination unit 76 determines that the difference value is larger than the tolerance according to the design intention or a region of interest of the user.

In a case where the determination unit 76 determines that it is not valid in the validity determination based on the allowable degree or the validity determination based on the tolerance after the rounding unit 74 has executed one of the first rounding and the second rounding, the rounding unit 74 may execute the other rounding. In this way, the secondary geometric element data after the rounding can be brought closer to the design intention of the user.

For example, when the number of significant digits is two digits, a reference value of a dimension of the secondary geometric element data is 0.01 mm. There may be CAD data with different minimum units, such as 0.01 in the case of using a micrometer and 0.05 in the case of using a vernier caliper, as the minimum units at the time of creating a design drawing of a member. Therefore, it is possible to provide the user with the secondary geometric element data and the secondary CAD data suitable for manufacturing, that is, more suitable for the design intention by determining the validity based on the allowable degree and executing the rounding determined to be valid. Further, the secondary CAD data and the design drawing can be brought close to each other by executing the determination based on the tolerance. As a result, it is possible to accurately confirm how much the geometric element of the workpiece W is reproduced with respect to the design drawing.

Further, the primary geometric element data extracted from the mesh data can also be converted to CAD data. As a result, for example, reverse engineering other than direct use in the design drawing, such as quantification of a manufacturing error, deformation due to use, and the like of the workpiece W, and investigation of causes of deformation, wear, and the like can be executed.

Further, it is possible to extract geometric element data matching or approximated to a predetermined basic shape from the mesh data acquired by the three-dimensional measurement apparatus 1 or the like, execute rounding of the data, and then, convert the data into CAD data. As a result, the design intention can be reflected on the geometric element data extracted from the mesh data.

In the present embodiment, geometric element data before rounding is held in the storage unit 54 as primary geometric element data, and the rounding unit 74 duplicates the primary geometric element data while holding the primary geometric element data in the storage unit 54, and executes rounding on the duplicated primary geometric element data to generate secondary geometric element data.

With such a configuration, it is possible to acquire the secondary geometric element data obtained by the rounding while leaving the primary geometric element data before rounding. As a result, even if the secondary geometric element data is created by executing the rounding, the primary geometric element data before rounding is held. Therefore, it is possible to easily confirm a deformation state such as an error or distortion with respect to the design data of the workpiece W, which is a measurement target, using the primary geometric element data before rounding.

In the present embodiment, the conversion unit 77 can generate primary CAD data obtained by converting the primary geometric element data, and can generate secondary CAD data obtained by converting the secondary geometric element data.

As a result, the primary CAD data that reproduces the actually measured shape of the workpiece W can be generated, and the secondary CAD data reflecting the design intention of the user can be generated. For example, analysis such as the quantification of a manufacturing error, deformation due to use, and the like of the workpiece W, and the investigation of causes of deformation, wear, and the like can be executed by comparing the primary CAD data with the design drawing. Further, the secondary CAD data, obtained by converting the secondary geometric element data in which a manufacturing error falling within a certain range is absorbed by the rounding, is easily used as the design drawing. As a result, it is possible to output CAD data suitable for a configuration desired to be reproduced, and the convenience of the user can be enhanced.

In the present embodiment, the rounding unit 74 can acquire the secondary geometric element data obtained by executing rounding on the primary geometric element data such that the number of significant digits becomes the number of significant digits to be processed that is coarser than the first number of significant digits which is the number of significant digits at the time of measurement.

Since the rounding is executed in this manner, it is possible to absorb a trivial error such as a manufacturing error that falls within a certain range included in the primary geometric element data, and to acquire the secondary geometric element data obtained by reflecting the design intention on the primary geometric element data.

In the present embodiment, the display control unit 75 displays the three-dimensional shape of the workpiece W on the display unit 51 with the second number of significant digits. The rounding unit 74 can acquire the secondary geometric element data obtained by rounding the primary geometric element data such that the number of significant digits becomes the number of significant digits to be processed that is coarser than the second number of significant digits.

Since the rounding is executed in this manner, it is possible to absorb a trivial error such as a manufacturing error that falls within a certain range included in the primary geometric element data, and to acquire the secondary geometric element data obtained by reflecting the design intention on the primary geometric element data.

In the present embodiment, the reception unit 72 can receive the settings of the design value and the tolerance. The rounding unit 74 determines whether to execute the rounding based on the difference value between the primary geometric element data and the design value, and the tolerance. The presence or absence of the rounding can be switched according to the tolerance with the design value.

According to the invention, the invention can be used in the reverse engineering support apparatus that supports reverse engineering of creating a CAD drawing from data obtained by measuring a three-dimensional shape.

What is claimed is:

1. A reverse engineering support apparatus that converts mesh data obtained by measuring a three-dimensional shape of a workpiece into CAD data and outputs the CAD data, the reverse engineering support apparatus comprising:
a data acquisition unit that acquires the mesh data;
an extraction unit that extracts geometric element data from the mesh data;
a rounding unit that executes rounding on a coordinate value or a dimensional value of the geometric element data extracted by the extraction unit;
a conversion unit that converts the geometric element data subjected to the rounding by the rounding unit into CAD data; and
an output unit that outputs the CAD data converted by the conversion unit.

2. The reverse engineering support apparatus according to claim 1, further comprising
a storage unit that stores the geometric element data before being subjected to rounding by the rounding unit as primary geometric element data,
wherein the rounding unit executes rounding on the primary geometric element data stored in the storage unit and generate secondary geometric element data.

3. The reverse engineering support apparatus according to claim 2, further comprising
a reception unit that receives selection of a conversion mode for executing conversion into CAD data from a first conversion mode of generating primary CAD data obtained by converting the primary geometric element data before the rounding into CAD data and a second conversion mode of generating secondary CAD data obtained by converting the secondary geometric element data after the rounding into CAD data,
wherein the conversion unit executes the conversion into the CAD data based on the conversion mode received by the reception unit.

4. The reverse engineering support apparatus according to claim 1, wherein
the rounding unit executes the rounding with a number of significant digits to be processed that is coarser than a first number of significant digits which is the number of significant digits in workpiece measurement.

5. The reverse engineering support apparatus according to claim 1, further comprising
a display control unit that causes a display unit to display a three-dimensional shape based on the mesh data,
wherein the display control unit causes the display unit to display the three-dimensional shape with display resolution of a second number of significant digits which is a number of significant digits of the display unit, and
the rounding unit executes the rounding with a number of significant digits to be processed that is coarser than the second number of significant digits.

6. The reverse engineering support apparatus according to claim 3, wherein
the reception unit receives inputs of a design value and a tolerance corresponding to the workpiece,
the rounding unit determines whether to execute the rounding based on whether a difference value between the primary geometric element data and the design value is larger than the tolerance, and
the conversion unit converts the primary geometric element data into the primary CAD data in the first conversion mode in a case where it is determined that the difference value between the primary geometric element data and the design value is larger than the tolerance by the determination, and converts the secondary geometric element data into the secondary CAD data in the second conversion mode in a case where it is determined that the difference value between the primary geometric element data and the design value is smaller than the tolerance by the determination.

7. The reverse engineering support apparatus according to claim 3, wherein
the reception unit receives inputs of a design value and a tolerance corresponding to the workpiece,
the rounding unit determines whether to execute the rounding based on whether a difference value between the primary geometric element data and the design value is larger than the tolerance, and
the conversion unit converts the primary geometric element data into the primary CAD data in the first conversion mode in a case where the rounding unit determines that the difference value between the primary geometric element data and the design value is smaller than the tolerance by the determination, and converts the secondary geometric element data into the secondary CAD data in the second conversion mode in a case where the rounding unit determines that the difference value between the primary geometric element data and the design value is larger than the tolerance.

8. The reverse engineering support apparatus according to claim 3, wherein
the reception unit receives an input of an allowable degree corresponding to the geometric element data,
the extraction unit extracts a plurality of pieces of geometric element data from the mesh data,
the rounding unit determines, for each of the plurality of pieces of geometric element data, whether a difference between the coordinate value or the dimensional value of the secondary geometric element data and the coordinate value or the dimensional value of the primary geometric element data is larger than the allowable degree, and
the conversion unit converts the primary geometric element data for which the difference is determined to be larger than the allowable degree by the rounding unit into the primary CAD data in the first conversion mode, and converts the secondary geometric element data for which the difference is determined to be smaller than the allowable degree by the rounding unit into the secondary CAD data in the second conversion mode.

9. The reverse engineering support apparatus according to claim 3, wherein
the reception unit receives an input of an allowable degree corresponding to the geometric element data,
the extraction unit extracts a plurality of pieces of geometric element data from the mesh data,
the rounding unit determines, for each of the plurality of pieces of geometric element data, whether a difference between the coordinate value or the dimensional value of the secondary geometric element data and the coordinate value or the dimensional value of the primary geometric element data is larger than the allowable degree, and
the conversion unit converts the primary geometric element data for which the difference is determined to be smaller than the allowable degree by the rounding unit into the primary CAD data in the first conversion mode, and converts the secondary geometric element data for which the difference is determined to be larger than the allowable degree by the rounding unit into the secondary CAD data in the second conversion mode.

10. The reverse engineering support apparatus according to claim 2, wherein
the storage unit stores a reference table in which a plurality of types of geometric element data are associated with information on whether to execute rounding on coordinate values and dimensional values of the plurality of types of geometric element data, and
the rounding unit specifies a target to be subjected to the rounding based on the reference table stored in the storage unit, acquires at least one of a coordinate value or a dimensional value corresponding to the specified target, and executes the rounding.

11. The reverse engineering support apparatus according to claim 10, further comprising
a setting unit configured to make a setting of information of the reference table,
wherein the information of the reference table is updated according to the setting of the information of the reference table made by the setting unit.

12. The reverse engineering support apparatus according to claim 2, wherein
the extraction unit extracts a plurality of pieces of geometric element data from the mesh data,
the storage unit stores a processing setting table in which the plurality of pieces of geometric element data extracted by the extraction unit and reference values of the rounding are associated for each piece of the geometric element data, and
the rounding unit refers to the processing setting table stored in the storage unit, acquires a reference value corresponding to geometric element data for which the rounding is to be executed, and executes the rounding on at least one of the coordinate value or the dimensional value based on the acquired reference value.

13. The reverse engineering support apparatus according to claim 12, wherein
the processing setting table has an execution determination value used to determine whether to execute the rounding for each piece of the geometric element data, and
the rounding unit determines whether to execute the rounding based on the execution determination value of the processing setting table, and executes the rounding for the geometric element data for which it has been determined to execute the rounding by the determination.

14. The reverse engineering support apparatus according to claim 13, wherein
the conversion unit converts the secondary geometric element data subjected to the rounding into the secondary CAD data for the geometric element data for which it has been determined to execute the rounding based on the execution determination value, and converts the primary geometric element data into the primary CAD data for the geometric element data for which it has been determined not to execute the rounding based on the execution determination value, and
the output unit outputs CAD data in which the primary CAD data and the secondary CAD data are assembled.

15. The reverse engineering support apparatus according to claim 2, wherein
the conversion unit converts at least one piece of primary geometric element data into the primary CAD data and converts at least one piece of secondary geometric element data into the secondary CAD data, and
the output unit outputs CAD data in which the primary CAD data and the secondary CAD data are assembled.
